(19) United States
(12) Patent Application Publication
(10) Pub. No.: US 2025/0123827 A1
(43) Pub. Date: Apr. 17, 2025

(54) LIFECYCLE MANAGEMENT OF AUTONOMOUS CLUSTERS IN A VIRTUAL COMPUTING ENVIRONMENT

(71) Applicant: VMware LLC, Palo Alto, CA (US)

(72) Inventors: Brian Masao Oki, San Jose, CA (US); Anton Valentinov Donchevski, Stara Zagora (BG); Ivaylo Vladimirov Loboshki, Sofia (BG); Yuedong Mu, San Jose, CA (US); Ivaylo Radoslavov Radev, Sofia (BG)

(21) Appl. No.: 18/487,708

(22) Filed: Oct. 16, 2023

(51) Int. Cl. G06F 8/61

(52) U.S. Cl. CPC G06F 8/61

(57) ABSTRACT

Systems, apparatus, articles of manufacture, and methods are disclosed to detect an installation script, the installation script including a second version of software in system storage of a first cluster of a plurality of clusters, a first version of the software installed in the first cluster, and after execution of the first version of the software by a first cluster control plane (CCP) pod is stopped, start execution of a second CCP pod, the second CCP pod instantiated with the second version of the software; and interface circuitry to direct an application programming interface (API) operation request received at the first cluster to the second CCP pod without directing the API operation request to the first CCP pod.

### FIELD OF THE DISCLOSURE

This disclosure relates generally to virtual computing and, more particularly, to lifecycle management of autonomous clusters in a virtual computing environment.

### BACKGROUND

Virtualization of computer systems provides numerous benefits such as the execution of multiple computer systems on a single hardware computer, the replication of computer systems, the extension of computer systems across multiple hardware computers, etc. “Infrastructure-as-a-Service” (also commonly referred to as “IaaS”) generally describes a suite of technologies provided by a service provider as an integrated solution to allow for elastic creation of a virtualized, networked, and pooled computing platform. By providing ready access to hardware resources to run an application, a computing platform enables developers to build, deploy, and manage the lifecycle of a web application (or any other type of networked application).

Virtual computing environments may be composed of many processing units (e.g., servers). The processing units may be installed in standardized frames, known as racks, which provide efficient use of floor space by allowing the processing units to be stacked vertically. The racks may additionally include other components of a virtual computing environment such as storage devices, networking devices (e.g., switches), etc.

### BRIEF DESCRIPTION OF THE DRAWINGS

FIG. 1A is a prior provisioning environment that includes prior compute clusters at a first time.

FIG. 1B is the prior provisioning environment of FIG. 1A that includes prior compute clusters at a second time.

FIG. 2A is an example provisioning environment that includes autonomous compute clusters at a first time.

FIG. 2B is the example provisioning environment of FIG. 2A that includes autonomous compute clusters at a second time.

FIG. 2C is a system diagram of another example provisioning environment that includes a provisioning service and a first autonomous compute cluster.

FIG. 3A is a block diagram of an example provisioning service that can send requests to an infravisor overlay network between three autonomous compute clusters.

FIG. 3B is a block diagram of an example infravisor overlay network between three autonomous compute clusters that can receive requests from the provisioning service of FIG. 3A.

FIG. 4 is a block diagram of an example provisioning service.

FIG. 5A is a block diagram of an example provisioning service with the capability to communicate with autonomous compute clusters.

FIG. 5B is a block diagram of an example control plane which communicates with the provisioning service of FIG. 5A.

FIG. 6 is a block diagram of an example implementation of the infravisor of FIG. 3B.

FIG. 7A is an example environment of a first autonomous compute cluster and a second autonomous compute cluster at a first time.

FIG. 7B is an example environment of the first autonomous compute cluster and

the second autonomous compute cluster of FIG. 7A at a second time.

FIG. 7C is an example environment of the first autonomous compute cluster and the second autonomous compute cluster of FIG. 7A at a third time.

FIG. 8 is an example timing diagram for operations executed by the first autonomous compute cluster of FIG. 2B.

FIGS. 9-11 are flowcharts representative of example machine readable instructions and/or example operations that may be executed, instantiated, and/or performed by example programmable circuitry to implement the infravisor of FIG. 3B to cease first operations of a first CCP pod and schedule second operations of the first CCP pod to be executed on a second CCP pod.

FIG. 12 is a flowchart representative of example machine readable instructions and/or example operations that may be executed, instantiated, and/or performed by example programmable circuitry to implement the infravisor of FIG. 3B to cease execution of a first CCP pod and start execution of a second CCP pod.

FIG. 13 is a block diagram of an example processing platform including programmable circuitry structured to execute, instantiate, and/or perform the example machine readable instructions and/or perform the example operations of FIGS. 9-12 to implement the infravisor of FIG. 3B.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Computer networks often include clusters of computers (which may be implemented as virtual machines running on a physical device) that are networked together to operate as a single computer/computer system. Each cluster has an assigned number of hosts. Hosts are also referred to herein as members. In examples disclosed herein, a host is hardware that runs a hypervisor to support one or more virtual machines. In some examples, such hardware is a server (e.g., a server host). In other examples, such hardware is implemented using distributed components (e.g., processors, graphics processors, memory, storage, network interfaces, hardware accelerators, etc.) across multiple drawers in a physical rack and/or across multiple physical racks. For example, ones of the distributed components can be provisioned to work cooperatively to support an execution environment to run a hypervisor. The number of hosts included in a cluster is often fluid (e.g., variable, in flux, changing, etc.) as different ones of the hosts fail, are added, are brought offline, etc. for any of a variety of reasons. For example, in some instances, a network administrator removes, adds and/or swaps hosts from a cluster (e.g., via an administrator interface) as needed to support the changing needs of a cloud computing customer. In some examples, a single physical server may support multiple virtual machines. In examples disclosed herein, virtual machines are also referred to as nodes. In some examples, a cluster may include different virtual machines/nodes operating on different physical hosts.

The techniques disclosed herein relate to a Highly Available Cluster Control Plane (HACCP) initiative. One of the example components of the HACCP initiative is the autonomous compute cluster. As used herein, a highly available (HA) system is a system that includes resources being available for a high percentage (e.g., 99.999%) of the resources' expected duration of use. For example, an HA network is expected to be available even upon the failure of one or more network paths between nodes of the network. A network can be made to operate in HA mode by providing redundant network paths between nodes should a single network path fail.

The autonomous cluster is to stay available even if a provisioning service (e.g., VMware's vCenter® server management software, an advanced server management service, a centralized platform, etc.) is malfunctioning, is offline, is under repair, has failed and/or is otherwise unavailable. Examples disclosed herein may be used to upgrade (e.g., to update, to cycle through the life stages (e.g., to lifecycle), etc.) autonomous compute clusters even if the provisioning service (e.g., vCenter® server management software) is malfunctioning, offline, or otherwise unavailable. The examples disclosed may cause the autonomous compute clusters to pass through the life stages of the autonomous clusters or “lifecycle” the autonomous compute clusters. Examples disclosed herein may also be used to provision operations by a first autonomous compute cluster while the provisioning service is unavailable and the first autonomous compute cluster is in an upgrade process. In some examples, if the provisioning service is malfunctioning, certain provisioning operations are blocked.

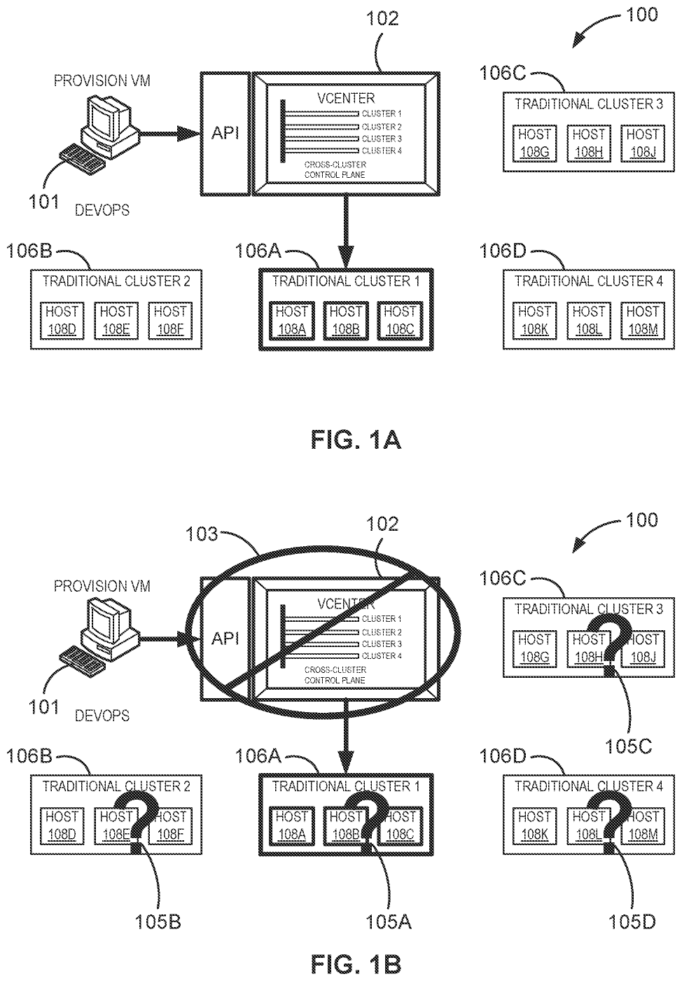

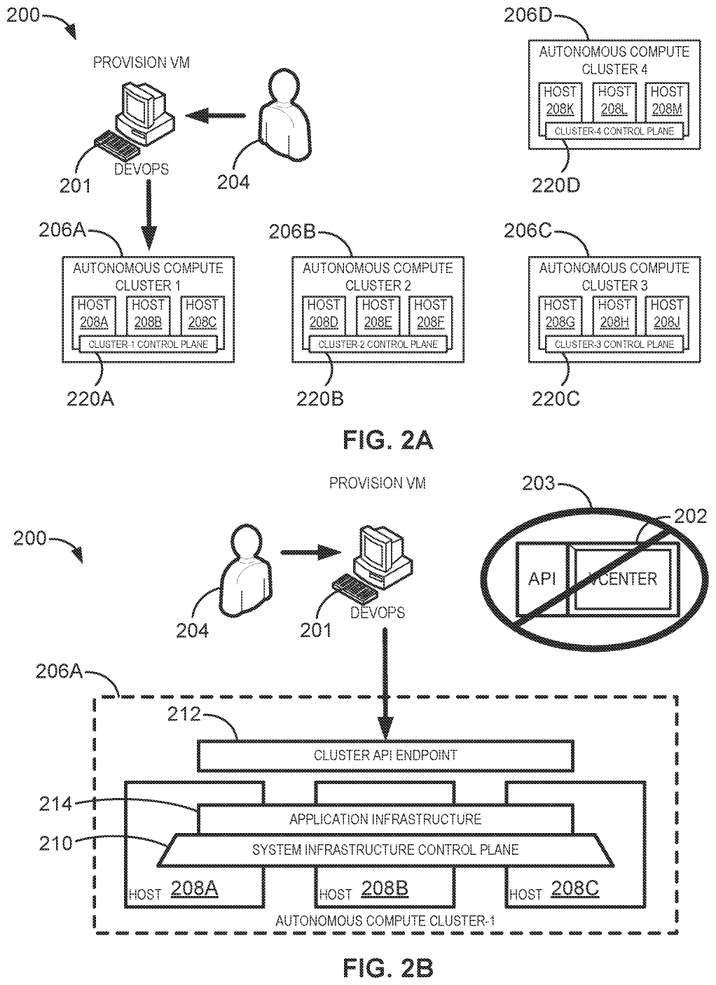

FIG. 1A is a prior provisioning environment 100 that includes a prior provisioning service 102 and compute clusters 106A, 106B, 106C, 106D at a first time. In FIG. 1A, a workstation 101, that is accessible by a developer, submits a provisioning request to the prior provisioning service 102 via an application programming interface (API). The prior provisioning service 102 is in connection with the compute clusters 106 (e.g., the first compute cluster-1 106A, the second compute cluster-2 106B, the third compute cluster-3 106C, and the fourth compute cluster-4 106D) via a cross-cluster control plane.

The first compute cluster-1 106A includes a first host 108A, a second host 108B, and a third host 108C. Similarly, the second compute cluster-2 106B includes a fourth host 108D, a fifth host 108E, and a sixth host 108F. The third compute cluster-3 106C includes a seventh host 108G, an eighth host 108H, and a ninth host 108J, and the fourth compute cluster-4 106D includes a tenth host 108K, an eleventh host 108L, and a twelfth host 108M.

FIG. 1B is a the prior provisioning environment 100 of FIG. 1 that includes the prior provisioning service 102 and the compute clusters 106A, 106B, 106C, 106D at a second time. At the second time, the prior provisioning service 102 is no longer available. This is depicted by a prohibition sign 103. For example, the prior provisioning service 102 may be offline, experiencing a technical malfunction, or rebooting, etc. Based on the unavailability of the prior provisioning service 102, the provisioning request from the example workstation 101 is unable to be transmitted to the example compute clusters 106A, 106B, 106C, 106D. This is illustrated by question marks 105 (e.g., a first question mark 105A for the first compute cluster-1 106A, a second question mark 105B for the second compute cluster-2 106B, a third question mark 105C for the third compute cluster-3 106C, and a fourth question mark 105D for the fourth compute cluster-4 106D). The clusters 106A, 106B, 106C, 106D are not highly available because based on the unavailability of the prior provisioning service 102, the compute clusters 106 are unable to receive provisioning requests (or any type of request from the example workstation 101) and thus unable to be updated in real-time.

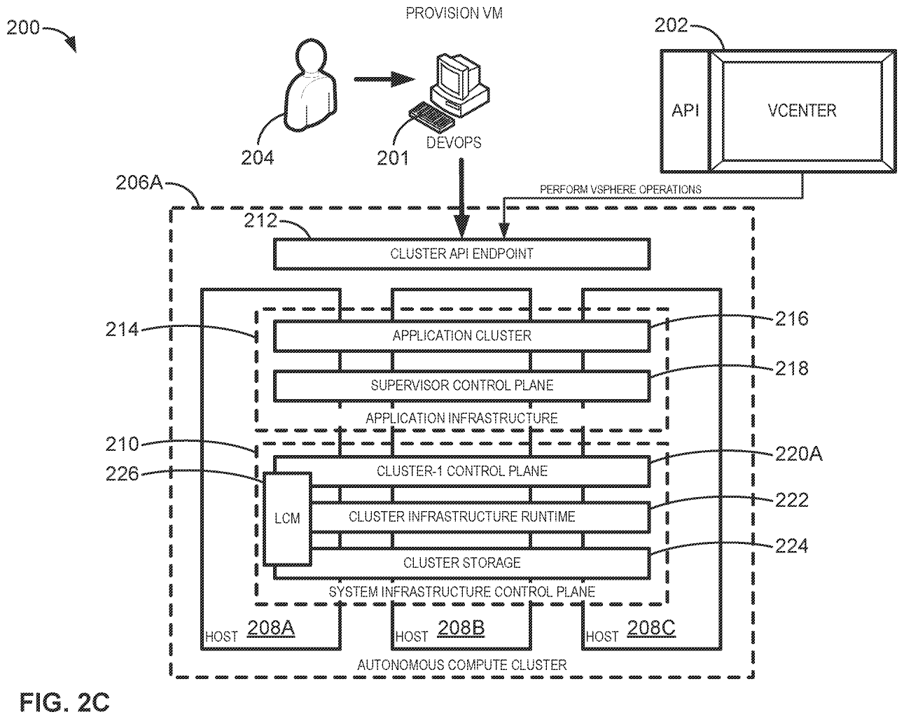

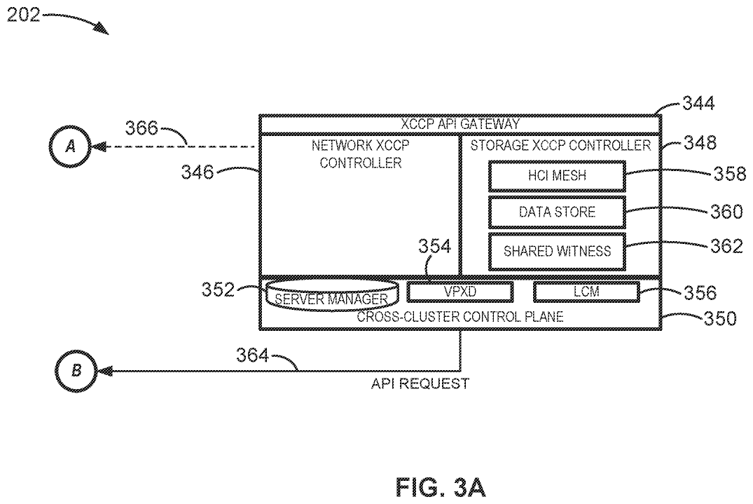

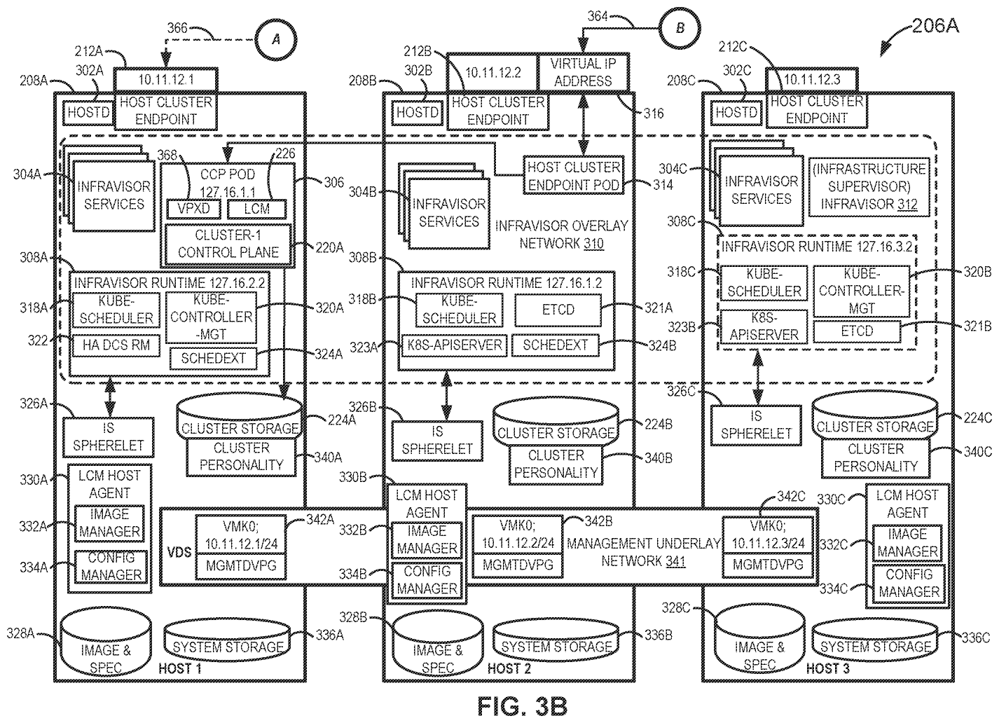

FIG. 2A is an example provisioning environment 200 including example autonomous compute clusters 206A, 206B, 206C, 206D. The example autonomous compute clusters 206A, 206B, 206C, 206D include corresponding individualized cluster control planes 220A, 220B, 220C, 220D. For example, the first autonomous compute cluster-1 206A includes the first cluster-1 control plane 220A. The example first autonomous compute cluster-1 206A is considered autonomous because the first autonomous compute cluster-1 206A has autonomous properties. Some of the example autonomous properties include being self-contained, being available for API operations, being a single communication endpoint, being a standalone host as a singleton autonomous host cluster, having a cluster state being stored in a cluster storage, having an inventory of cloud infrastructure resources that are owned by the cluster, having a cluster document that declaratively specifies a desired cluster state, having a simple management of cluster-wide infrastructure services, having a desired state platform for lifecycle infrastructure management to ensure compliance, and being manageable by any provisioning service. The example first autonomous compute cluster-1 206A includes multiple hosts 208 (e.g., an example first host 208A, an example second host 208B, and an example third host 208C).

The example second autonomous compute cluster-2 206B includes a second cluster-2 control plane 220B that is to manage the resources of an example fourth host 208D, an example fifth host 208E, and an example sixth host 208F. The example third autonomous compute cluster-3 206C includes an example third cluster-3 control plane 220C that is to manage the resources of an example seventh host 208G, an example eighth host 208H, and an example ninth host 208J. The example fourth autonomous compute cluster-4 206D includes an example fourth cluster-4 control plane 220D that is to manage the resources of an example tenth host 208K, an example eleventh host 208L, and an example twelfth host 208M. The hosts 208 of the example provisioning environment 200 may be implemented using VMware® ESXi hypervisors. A VMware® ESXi hypervisor is a bare-metal hypervisor that runs directly on hardware without a need for an underlying operating system.

The example first autonomous compute cluster-1 206A receives a provisioning request to provision a VM (or any other type of request) from an example workstation 201. In some examples, requests are submitted by a developer 204 via the example workstation 201. In other examples, requests are submitted by a process (e.g., an automated process) or through any other suitable means. In any case, in the example FIG. 2A, the first autonomous compute cluster-1 206A receives the provisioning request using the example first cluster-1 control plane 220A and transmits the provisioning request to the three example hosts 208A, 208B, 208C. In some examples, each of the autonomous compute clusters 206A, 206B, 206C, 206D is self-contained and therefore does not depend on ones of the other autonomous compute clusters 206A, 206B, 206C, 206D. In such examples, the first autonomous compute cluster-1 206A works independently from the other example autonomous compute clusters 206B, 206C, 206D.

FIG. 2B is the example provisioning environment 200 showing a detailed view of the example first autonomous compute cluster-1 206A. Although for ease of illustration example FIG. 2B does not show the second autonomous compute cluster-2 206B, the third autonomous compute cluster-3 206C, and the fourth autonomous compute cluster-4 206D of FIG. 2A, the autonomous compute clusters 206B, 206C, 206D are substantially similar or identical to the example first autonomous compute cluster-1 206A shown in FIG. 2B. In the example of FIG. 2B, the provisioning environment 200 includes a provisioning service 202 that is experiencing a malfunction, as indicated by a prohibition sign 203. However, despite the unavailability of the example provisioning service 202, the example workstation 201 is able to submit a provisioning request to the example first autonomous compute cluster-1 206A.

The example developer 204 which has access to a devops account (e.g., devops persona, a developer-operations account, developer-operations credentials) uses the example workstation 201 to submit the request (e.g., a provision a workload request, a provisioning request, a manage a workload request, a managing request, a monitor a workload request, a monitoring request, etc.) to an example cluster API endpoint 212 of the example first autonomous compute cluster-1 206A. In FIG. 2B, the example system infrastructure control plane 210 and an example application infrastructure 214 are shown in communication with the example three hosts 208A, 208B, 208C.

FIG. 2C is the example provisioning environment 200 that includes the provisioning service 202 and the example first autonomous compute cluster-1 206A. Although for ease of illustration example FIG. 2C does not show the second autonomous compute cluster-2 206B, the third autonomous cluster-3 206C, and the fourth autonomous compute cluster-4 206D of FIG. 2A, the autonomous compute clusters 206B, 206C, 206D are substantially similar or identical to the example first autonomous compute cluster-1 206A shown in FIG. 2C. FIG. 2C shows additional detail of the example first cluster-1 control plane 220A and the example application infrastructure 214.

The example first cluster-1 control plane 220A is included in an example system infrastructure control plane 210. The example system infrastructure control plane 210 includes the example first cluster-1 control plane 220A, an example cluster infrastructure runtime 222, an example cluster storage 224, and an example life cycle manager (LCM) 226. The example application infrastructure 214 includes an example application development cluster 216 and an example supervisor control plane 218. In some examples, the application development cluster 216 may be implemented using a Tanzu® application platform provided by VMware, Inc. In the example of FIG. 2C, the provisioning service 202 is available (e.g., not malfunctioning) and is able to transmit requests (e.g., provisioning requests, any other type of request) to the example cluster API endpoint 212 of the first autonomous compute cluster-1 206A. In addition, the example workstation 201 is also able to transmit requests (e.g., provisioning requests or any other requests) to the example cluster API endpoint 212 of the first autonomous compute cluster-1 206A.

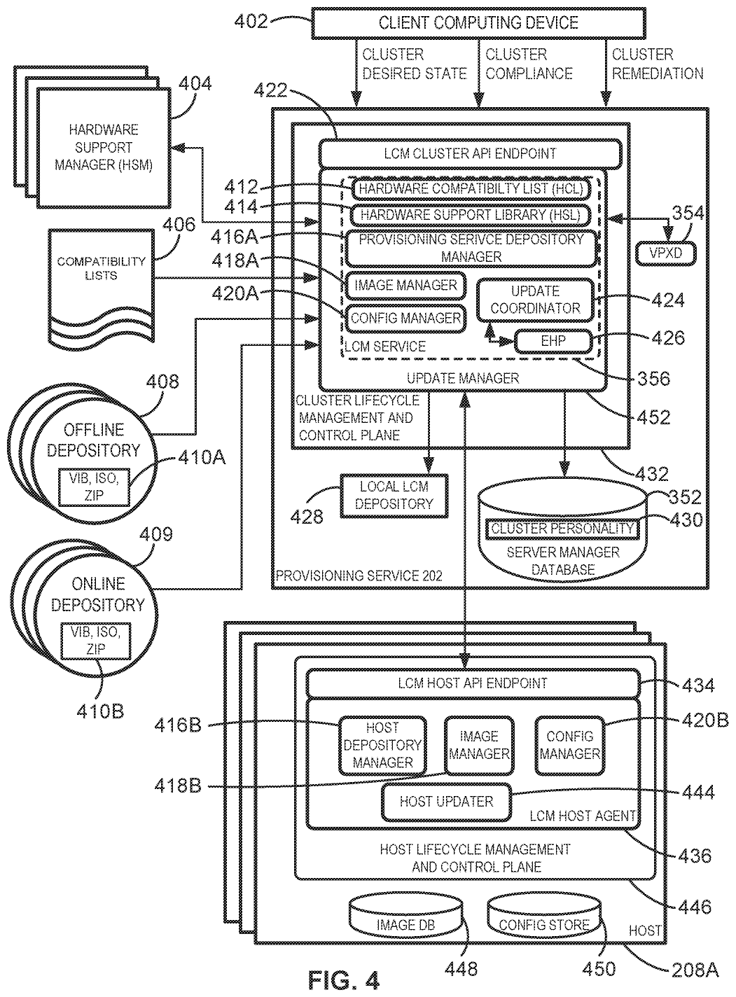

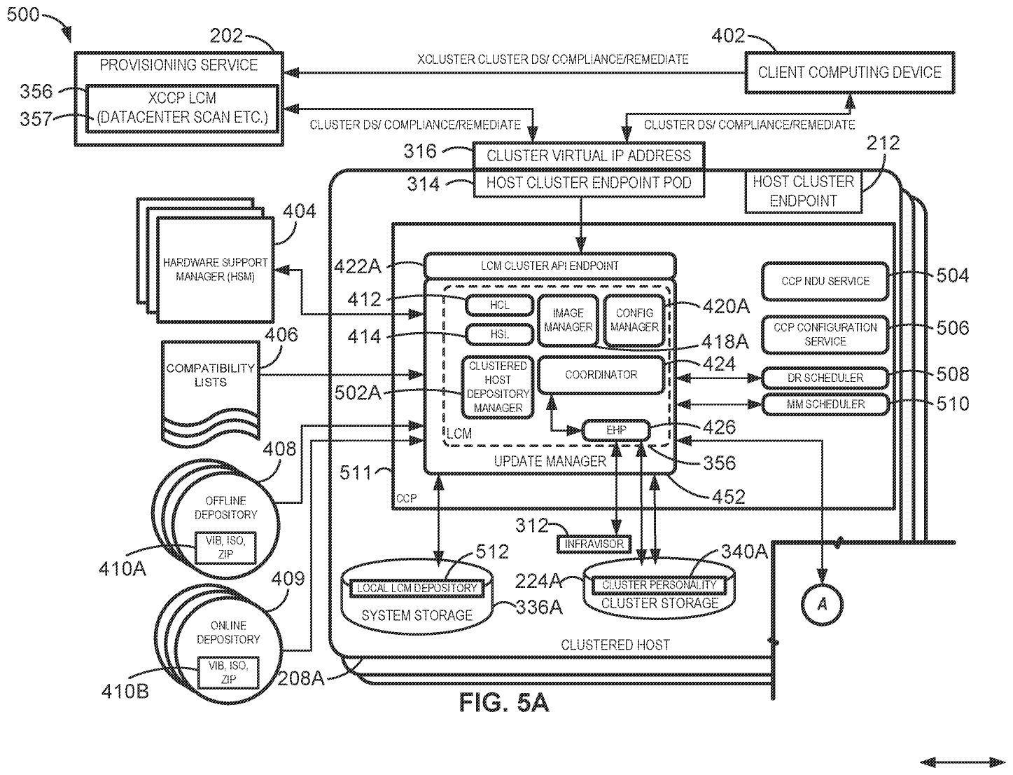

FIG. 3A is an example block diagram of the example provisioning service 202 of FIGS. 2B-2C that can send requests to an example infravisor overlay network 310 (FIG. 3B) between three hosts 208A, 208B, 208C (FIG. 3B) of the example first autonomous compute cluster-1 206A (FIG. 3B). In some examples, the provisioning service 202 is implemented by VMware's vCenter® server management software. The example provisioning service 202 includes an example cross-cluster control plane (XCCP) API gateway 344, an example network XCCP controller 346, an example storage XCCP controller 348, and an example cross-cluster control plane 350. The example storage XCCP controller 348 includes an example hyperconverged infrastructure (HCl) mesh 358, an example data store 360, and an example shared witness 362. The example cross-cluster control plane 350 includes an example server manager database 352, an example virtual provisioning cross-cluster daemon (VPXD) 354, and an example lifecycle manager (LCM) service 356. The example LCM service 356 is a lifecycle manager service which can update hosts 208A, 208B, 208C (FIG. 2A) of autonomous compute clusters 206A, 206B, 206C, 206D (FIG. 2A). The example VPXD 354 persists an example CCP inventory and XCCP state in the example server manager database 352. In some examples, the server manager database 352 may be implemented using a VMware vCenter® database (e.g., VCDB). The example cross-cluster control plane 350 of the provisioning service 202 sends an example first provisioning request 364 (e.g., an API request) to the example hosts 208A, 208B, 208C (FIG. 3B) of the example first autonomous compute cluster-1 206A of FIG. 3B. The example first provisioning request 364 (e.g., an API request) of FIG. 3A is received at an example virtual IP address 316 (FIG. 3B) of the example second host 208B (FIG. 3B). The example second host 208B (FIG. 3B) distributes the example first provisioning request 364 to the example first host 208A (FIG. 3B) and the example third host 208C (FIG. 3B). The example network XCCP controller 346 sends an example second provisioning request 366 directly to the example first host 208A (FIG. 3B). The example second provisioning request 366 is received at the example first host cluster endpoint 212A which is responsible for routing the example second provisioning request 366 to the CCP pod 306 (e.g., the local host control plane, the cluster control plane services, etc.) of FIG. 3B.

FIG. 3B is a block diagram of the example first autonomous compute cluster-1 206A including the example first host 208A, the example second host 208B, and the example third host 208C. The example first host 208A includes an example first host daemon (hostd) 302A, the example second host 208B includes an example second hostd 302B, and the example third host 208C includes an example third hostd 302C. In examples disclosed herein, a host daemon (hostd) operates as a communication layer between a virtual kernel (e.g., VMKernel) of a host and one or more virtual machines running on that host. The example first autonomous compute cluster-1 206A includes infravisor services 304 shown as an example first infravisor service 304A associated with the example first host 208A, an example second infravisor service 304B associated with the example second host 208B, and an example third infravisor service 304C associated with the example third host 208C. In some examples, the hosts 208A, 208B, 208C are implemented using VMware® ESXi hypervisor software. In examples disclosed herein, VMware® ESXi hypervisor software is installed on a physical host and runs on bare-metal (e.g., hardware) without an underlying operating system. The VMware® ESXi hypervisor software instantiates one or more virtual machines that run as pods.

The example infravisor overlay network 310 includes an example first infravisor runtime service 308A associated with the example first host 208A, an example second infravisor runtime service 308B associated with the example second host 208B, and an example third infravisor runtime service 308C associated with the example third host 208C. The example infravisor overlay network 310 includes an example infravisor 312. The example infravisor 312 is a combination of the words “infrastructure” and “supervisor” because the infravisor 312 provides supervisor services for the cluster infrastructure. For example, the example infravisor 312 is to monitor and update the example CCP pod 306. The example infravisor 312 is to ensure that the example infravisor services 304A, 304B, 304C are running and functional in the example first autonomous compute cluster-1 206A with minimal administrative intervention. The example infravisor overlay network 310 is a convenient private network for the example infravisor runtime services 308A, 308B, 308C, the example infravisor services 304A, 304B, 304C, and the example CCP pod 306 to communicate.

The example CCP pod 306 includes the example first cluster-1 control plane 220A, the example life cycle manager (LCM) 226, and the example VPXD 368. The example VPXD 368 of FIG. 3B is similar to the example VPXD 354 of FIG. 3A of the example provisioning service 202 (FIG. 3A), but the example VPXD 368 of FIG. 3B is associated with the example CCP pod 306 and the example first autonomous compute cluster-1 206A (FIG. 3B).

The example first infravisor runtime service 308A includes example Kubernetes® components shown as an example first Kubernetes scheduler 318A, an example first Kubernetes controller manager 320A, an example Highly-Available (HA) Distributed-Cluster Services (DCS) Resource-Manager (RM) 322 (e.g., HA DCS RM 322), and an example schedext 324A. The example second infravisor runtime service 308B includes an example second Kubernetes scheduler 318B, an example first ETCD 321A (e.g., a distributed key-value store), an example first Kubernetes (K8S) API-server 323A, and an example second schedext 324B. The example third infravisor runtime service 308C includes an example third Kubernetes scheduler 318C, an example second Kubernetes controller manager 320B, an example second Kubernetes (K8S) API-server 323B, and an example second ETCD 321B.

The example infravisor runtime services 308A, 308B, 308C are in connection with the example IS-spherelets 326A, 326B, 326C. The example first Kubernetes API-server 323A and the example second Kubernetes API-server 323B are connected to the example second IS-spherelet 326B and the example third IS-spherelet 326C, respectively. The example IS-spherelet 326 is a local per host controller that watches and realizes the state of services in the first autonomous compute cluster-1 206A. The example first IS-spherelet 326A is an example entity on the example first host 208A that launches the example CCP pod 306 on the example first host 208A. The example first IS-spherelet 326A monitors the state of the CCP pod 306 (e.g., monitors the liveness of the CCP pod 306) and restarts the CCP pod 306 when the CCP pod 306 fails. In the example of FIG. 3B, the CCP pod 306 is associated with the first host 208A. However, in other examples, the example second IS-spherelet 326B may launch the CCP pod 306 on the example second host 208B.

The example first host 208A includes a first LCM host agent 330A, the example second host 208B includes an example second LCM host agent 330B, and the example third host 208C includes an example third LCM host agent 330C. The example LCM host agents 330A, 330B, 330C include corresponding image managers 332A, 332B, 332C and corresponding configuration managers 334A, 334B, 334C. The example management underlay network 341 is implemented using a virtual distributed switch (VDS) and includes three instances of virtual kernel interfaces (VMK0) 342A, 342B, 342C. In the example of FIG. 3B, the management underlay network 341 communicatively links the hosts 208A, 208B, 208C and therefore communicatively links the system components of the hosts 208A, 208B, 208C.

The example hosts 208A, 208B, 208C include respective cluster storages 224A, 224B, 224C. The example cluster storages 224A, 224B, 224C include respective example cluster personality data 340A, 340B, 340C. The example hosts 208A, 208B, 208C include respective image and specification databases 328A, 328B, 328C and respective example system storages 336A, 336B, 336C. In some examples, the first system storage 336A is a local storage or a local database that is associated with the example first host 208A.

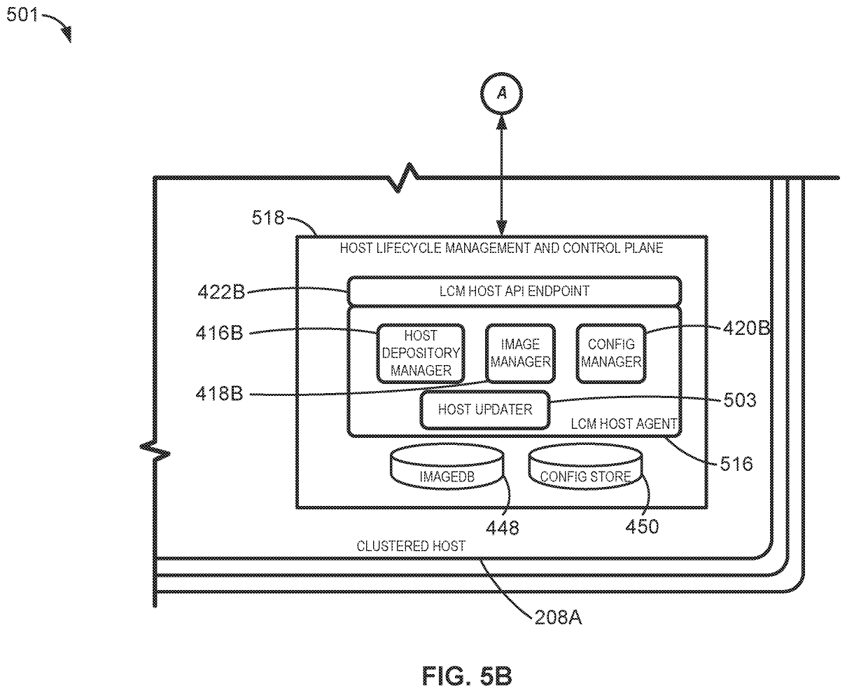

FIG. 4 shows the provisioning service 202 of FIGS. 2C and 3A in communication with the first host 208A. Example FIG. 4 also shows an example client computing device 402, an example hardware support manager (HSM) 404, example compatibility lists 406, an example offline depository 408, and an example online depository 409.

An example customer (e.g., user, client, person), through the use of the client computing device 402, is to communicate a cluster target state (e.g., cluster desired state), a cluster compliance and a cluster remediation to the example provisioning service 202. The example client computing device 402 communicates with an example LCM cluster API endpoint 422. The example LCM cluster API endpoint 422 is an example component of the example provisioning service 202. In some examples, the client computing device transmits a cluster desired state document which includes the aspects of a hypervisor image, firmware, and configuration.

In some examples, the hardware support manager 404 is implemented by a hardware manufacturer. In such examples, the hardware manufacturer makes updates to the computing hardware which deploys the virtual machines. In some examples, the update or upgrade to the computing hardware includes a software driver which is transmitted by the hardware support manager 404 to the example hardware support library (HSL) service 414. In some examples, the HSL service 414 is a library that includes a compatibility list of firmware updates that, when installed, are predicted to work on hardware. The example HSL service 414 is to work with external hardware manufacturers to update the host software components and firmware to a version of a hardware support package that is selected by an example developer as part of the target state (e.g., desired state) of the example autonomous compute clusters 206A, 206B, 206C.

The example compatibility lists 406 is to list storage virtualization software updates (e.g., VMware's vSAN® storage virtualization software updates), cloud provider compatibility information (e.g., VMware's Compatibility Guide (VCG)) and hardware compatibility lists (HCL) for access by the example hardware compatibility list (HCL) service 412. In some examples, the HCL service 412 (e.g., hardware compatibility list service) is a library that includes a compatibility list of firmware updates that, when installed, are predicted to work on hardware. In other examples, the HCL service 412 is a library that validates devices (e.g., servers, PCI devices, storage devices) to comply with the compatibility lists 406 (e.g., the cloud provider compatibility information (e.g., VMware's Compatibility Guide (VCG)) and the storage virtualization software updates (VMware's vSAN® storage virtualization software updates).

The example provisioning service depository manager 416A (e.g., PS depository manager) is to communicate with the example offline depository 408 and the example online depository 409. The example offline depository 408 stores update files 410A and the example online depository 409 stores update files 410B. Some example formats that the example update files 410 may be packaged as are an installation file (e.g., VMware® virtual infrastructure bundle (VIB) file), an ISO (e.g., optical disc image) file, or a compressed file (e.g., compressed ZIP file). The example provisioning service depository manager 416A, after accessing (e.g., retrieving) the example update files 410A from the offline depository 408 and the example update files 410B from the online depository 409, stores the update files 410 in an example local LCM depository 428.

The example image manager 418A provides upgrade support for host software and firmware image. In some examples, the image manager 418A uses the HCL service 412 (e.g., hardware compatibility list) and the compatibility lists 406 to confirm that the upgraded host software and the upgraded firmware images are compatible with hardware. In some examples, the image manager 418A is to manage software, drivers, and/or files that are able to be installed.

The example configuration manager 420A is to provide change management for host software configuration. In some examples, the configuration manager 420A is to store example configurations used in provisioning hosts.

The example update coordinator 424 is to communicate with the example host health service (EHP) 426 (e.g., VMware® ESXi Health Perspectives service). The example update coordinator 424 is to provide cluster orchestration of image and configuration remediation by communicating with the example image manager 418A and the example configuration manager 420A. The example EHP service 426 is to determine whether a host action (e.g., VMware® ESXi® action) is safe to perform. For example, to determine whether the example third host 208C (FIG. 2A) can safely be removed from the example first autonomous compute cluster-1 206A, the example EHP service 426 queries a compute health monitoring service (e.g., VMware's vSAN® storage virtualization software health service (e.g., vSAN® Health)). The health service checks whether the data is evacuated from the third host 208C (FIG. 2A) then responds to the example EHP service 426 with the results.

The example update manager 452 is to communicate with the example local LCM depository 428, the example VPXD 354, the example server manager database 352, and the example LCM host API endpoint 434 of the example first host 208A (e.g., a first ESXi host). The example server manager database 352 includes an example cluster personality 430 (e.g., a target configuration state of the cluster). The example VPXD 354 is to provide services used in cluster remediation such as distributed resource scheduler (DRS) and fault domain manager (FDM).

The example update manager 452 includes an example LCM service 356 (e.g., the LCM service 356 resides inside the example update manager 452). The example LCM service 356 includes the example HCL service 412, the example HSL service 414, the example provisioning service depository manager 416A, the example image manager 418A, the example configuration manager 420A, the example coordinator 424, and the example EHP service 426. The example LCM service 356 is to orchestrate example upgrades for the hypervisor image, the firmware, and/or the configuration across the autonomous compute clusters 206 (FIG. 2A). The example LCM service 356 utilizes a declarative cluster lifecycle management system.

The example first host 208A includes a host lifecycle management and control plane 446, an example image database 448, and an example configuration store 450. The example first host 208A includes a host lifecycle management and control plane 446 which is to receive updates from the cluster lifecycle management and control plane 432 of the example provisioning service and execute the updates on the first host 208A.

The example host lifecycle management and control plane 446 includes an example LCM host agent 436. The example LCM host agent 436 includes an example host depository manager 416B, an example image manager 418B, an example configuration manager 420B, and an example host updater 444. The example provisioning service depository manager 416A of the example provisioning service 202 is to track the depositories 408, 409 (e.g., depots) and the metadata associated with the depositories 408, 409. The example provisioning service depository manager 416A is to work with the example offline depository 408 and the example online depository 409. In some examples, the provisioning service depository manager 416A is to store depository data from the depositories 408, 409 to the example local LCM depository 428 of the example provisioning service 202.

The example host depository manager 416B of the example first host 208A is a proxy to the example local LCM depository 428 (e.g., remote local image depot) and the example online depository 409. The example host depository manager 416B is to download the update files 410B (e.g., VIB file, ISO file, ZIP file, etc.) from the online depository 409 and stage the update files 410B locally on the host 208A.

The example image manager 418A of the example provisioning service 202 is to provide upgrade support for the host software and firmware image. The example image manager uses HCL and VCG to confirm the upgraded software image is compatible with the example hardware. The example image manager 418B of the example first host 208A is responsible for the actual remediation of the host software image. The example image manager 418B is to store the image metadata that represents the running image on the example first host 208A in the example image database 448. In some examples, the image database 448 is a persistent datastore.

The example configuration manager 420A of the example provisioning service 202 is to provide change management for the host software configuration. The example configuration manager 420B of the example first host 208A is responsible for the actual remediation of the example host configuration. The example configuration manager 420B provides an extensible framework for features to integrate remediation and/or apply modules. The example configuration store 450 is a database to persist configuration locally on the example first host 208A. In some examples, the configuration store 450 is an SQLite® searchable database where configurations are backed by a schema (e.g., logical organization of data). For example, when an update file 410A or 410B (e.g., VIB file, ISO file, ZIP file, etc.) is installed on the example first host 208A, the schema gets loaded in the example configuration store 450.

The example host updater 444 of the example first host 208A is to apply the updates received at the example LCM host API endpoint 434 to the example first host 208A. In some examples, the host updater 444 orchestrates the remediation of the example image document and the example configuration document on the example first host 208A.

As illustrated in the example of FIG. 4, the example cluster lifecycle management and control plane 432 resides inside the provisioning service 202 and the example host lifecycle management and control plane 446 resides inside the first host 208A. The example cluster lifecycle management and control plane 432 orchestrates the remediation of the hosts 208A, 208B, 208C (FIG. 2C) inside a cluster (such as the example first autonomous compute cluster-1 206A of FIG. 2C) by applying patches, extensions and upgrades to the cluster. The example host lifecycle management and control plane 446 is to remediate the actual host (e.g., the first host 208A of FIG. 2C) by applying patches, extensions, and upgrades to the host.

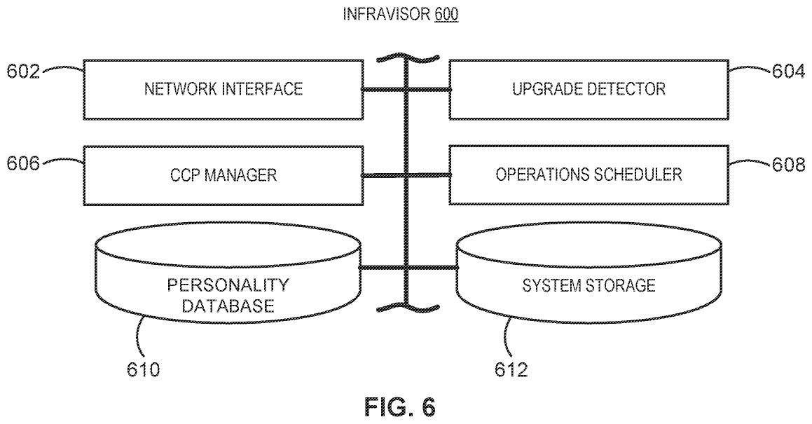

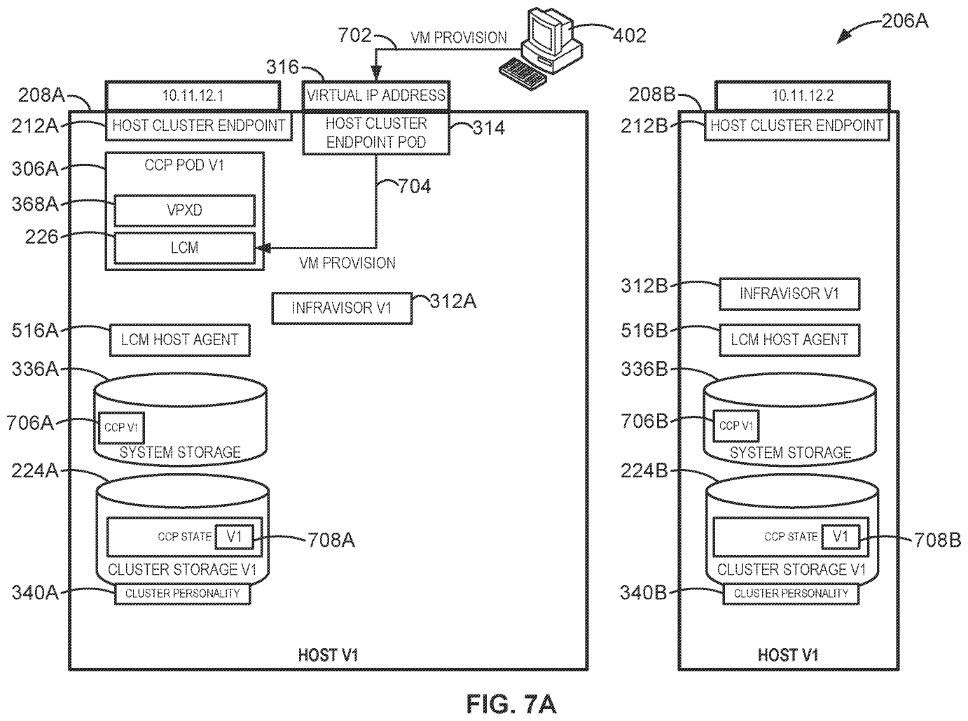

FIG. 5A illustrates an example first portion 500 of an example autonomous cluster system-level diagram and FIG. 5B illustrates an example second portion 501 of the example autonomous cluster system-level diagram.

Some of the example components of FIGS. 5A and 5B are existing dependencies for the LCM service 356, while some components are new dependencies for LCM service 356. In examples disclosed herein, a dependency is defined as a link between at least two virtual machines, where a first virtual machine uses (e.g., depends on, requires, etc.) services that are run on a second virtual machine. An existing dependency is defined as a dependency that exists between the components of FIG. 4. A new dependency is defined as a dependency that connects the components of FIGS. 5A and 5B that is not featured in FIG. 4. The example existing dependencies include the example hardware support manager 404, the example compatibility lists 406, the example offline depository 408, and the example online depository 409. The example new dependencies include the example system storage 336, the example cluster storage 224, and the example infravisor 312.

Some of the example components of FIGS. 5A and 5B are non-LCM components. These non-LCM components include the example cluster control plane non-disruptive upgrade service 504 (e.g., CCP NDU service) and the example cluster control plane configuration service 506 (e.g., CCP configuration service).

The example first portion 500 of the example autonomous cluster system-level diagram of FIG. 5A includes the example provisioning service 202, the example client computing device 402, the example first host 208A, the example hardware support manager 404, the example compatibility lists 406, the example offline depository 408, and the example online depository 409.

The example provisioning service 202 is simplified for the example of FIGS. 5A and 5B. The example provisioning service 202 includes the example LCM service 356 (e.g., cross-cluster control plane (XCCP) life cycle manager service) which includes a datacenter scan service 357. In some examples, the example datacenter scan service 357 is a controller which is to detect drift at a datacenter level.

The example first host 208A along with the example second host 208B (not shown in FIG. 5A) and the example third host 208C (not shown in FIG. 5A) form an example first autonomous compute cluster-1 206A (FIG. 2A). The example first host 208A receives provisioning requests from the example provisioning service 202 and the example client computing device 402. Some of these provisioning requests are “cluster DS,” “compliance,” and “remediate.” These provisioning requests confirm that the configuration information of the example hosts 208A, 208B, 208C is in compliance with a source of truth from the client computing device 402 or the example provisioning service 202. The example provisioning requests may update the configuration information of the example hosts 208A, 208B, 208C if the example configuration information is to be remediated. The example first host 208A receives these requests at the example virtual IP address 316, which transmits the request to the example host cluster endpoint pod 314, which transmits the request to the example LCM cluster API endpoint 422 of the example update manager 452. The example update manager 452 is to store information received in the request in a respective database (e.g., the first system storage 336A, the first cluster storage 224A) or use the example infravisor 312 to begin execution of the request. The example first system storage 336A includes an example LCM depository 512.

The example update manager 452 includes the example LCM cluster API endpoint 422A and the example HCL service 412, the example HSL service 414, the example image manager 418A, the example configuration manager 420A, the example coordinator 424, the example host health service 426, and an example clustered host depository manager 502A. The example clustered host depository manager 502A (e.g., CH depository manager) is configured to work with the example first system storage 336A. The example first system storage 336A provides replication services for the first host 208A inside the first autonomous compute cluster-1 206A. For example, the first system storage 336A is a “replicated depository” that is available on-demand for any of the hosts 208A, 208B, 208C that have the ability to run the life cycle management cluster control plane (CCP) 511. The example hosts 208A, 208B, 208C are able to use the replicated depository without the need to resync from the example online depository 409 and without the need to attach every host 208A, 208B, 208C to the example offline depository 408.

The example CCP NDU service 504 is to schedule operations to be executed by the first autonomous compute cluster-1 206A (FIG. 2C) so that the first autonomous compute cluster-1 206A (FIG. 2C) stays highly available through an update process. The example CCP NDU service 504 schedules the operations so that a user experience is not disrupted while the example first autonomous compute cluster-1 206A (FIG. 2B) is in the update process.

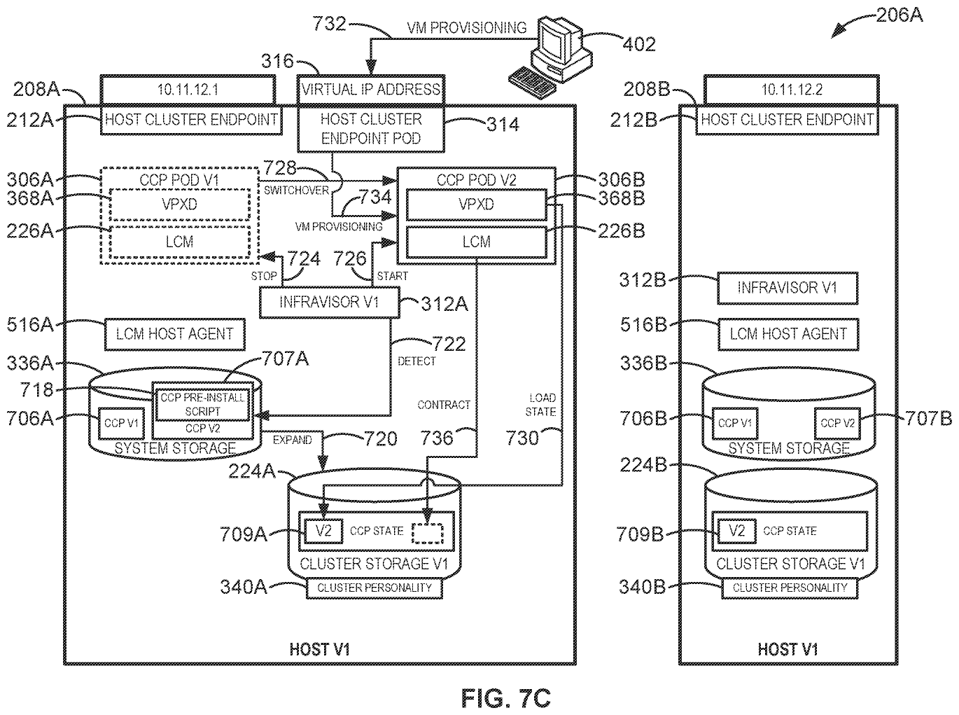

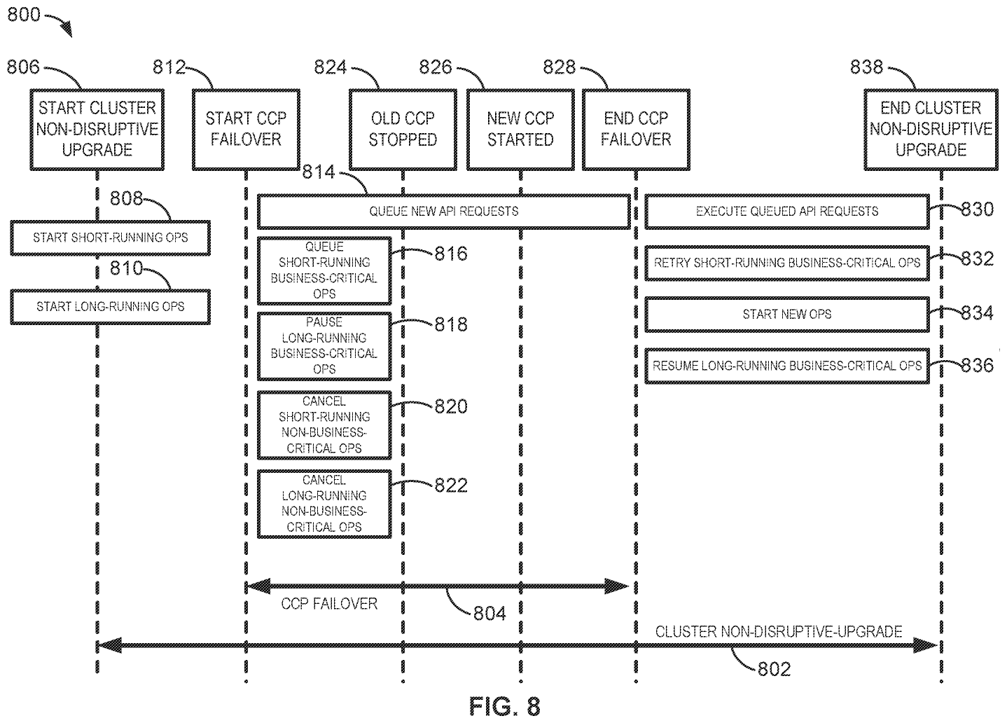

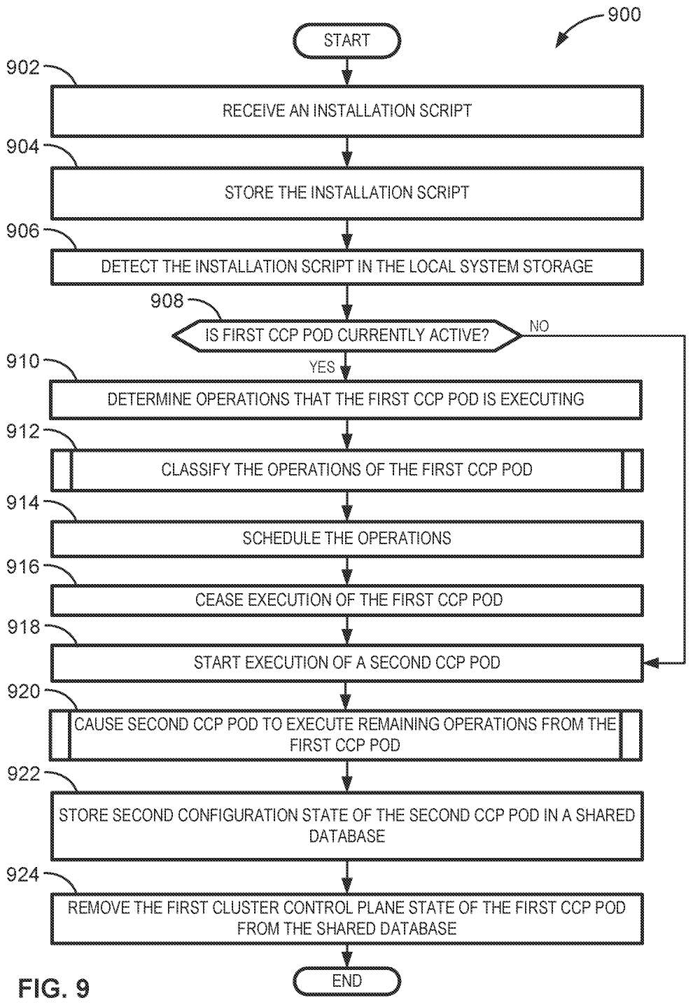

The example distributed resource (DR) scheduler 508 is to automatically determine initial virtual machine placement and dynamic virtual machine migration to balance load. In some examples, the DR scheduler 508 balances load based on the resource allocations and policies specified by administrators. The example maintenance mode (MM) scheduler 510 is to schedule maintenance mode of the example first host 208A. For example, the first host 208A may enter maintenance mode that the example first host 208A may be shut down, rebooted, and/or disconnected from the example first autonomous compute cluster-1 206A (FIG. 7C).

The example cross cluster control plane (CCP) 511 includes the example update manager 452, the example CCP NDU service 504, the example CCP configuration service 506, the example DR scheduler 508 and the example MM scheduler 510.

As illustrated in FIG. 5A, the example hosts 208A, 208B, 208C, 208D, 208E, 208F, 208G, 208H, 208J, 208K, 208L, 208M (FIG. 2A) of the example autonomous compute clusters 206A, 206B, 206C, 206D (FIG. 2A) can be upgraded when a provisioning service 202 is unavailable (e.g., malfunctioning). The example functionality of the LCM service 356 (FIG. 3A) resides in the example LCM host agents 330A, 330B, 330C (FIG. 3B) of the respective ones of the example hosts 208A, 208B, 208C (FIG. 3B). The example first autonomous compute cluster-1 206A (FIG. 2C) performs the life cycle update locally. In some examples, a migration-based upgrade exists to asynchronously upgrade the example CCP 511 before the example base image of the first host 208A is upgraded.

In some examples, cross-cluster dependencies exist, but the unavailability of a cross-cluster dependency is mitigated by the fact that the example first host 208A is not required to receive the provisioning request from the example provisioning service 202. The example first host 208A may receive the request directly from the dependencies. A first portion of the dependencies are centralized, and a second portion of the dependencies are external. Some of the centralized dependencies are the example online depository 409 and the example compatibility lists 406. One example of the external dependencies is the example hardware support manager 404.

FIG. 5B includes a host lifecycle management and control plane 518 that includes an example LCM host agent 516 and an example image database 448 and an example configuration store 450. The example LCM host agent 516 includes an example LCM host API endpoint 422B, an example host depository manager 416B, an example image manager 418B, an example configuration manager 420B, and an example host updater 503. The example host updater 503 is to support the installation of the example CCP pod 306 (FIG. 3B) and other infravisor services. The example host updater 503 is to perform installation based on the installation files in the system storage such as the image database 448 and the configuration store 450.

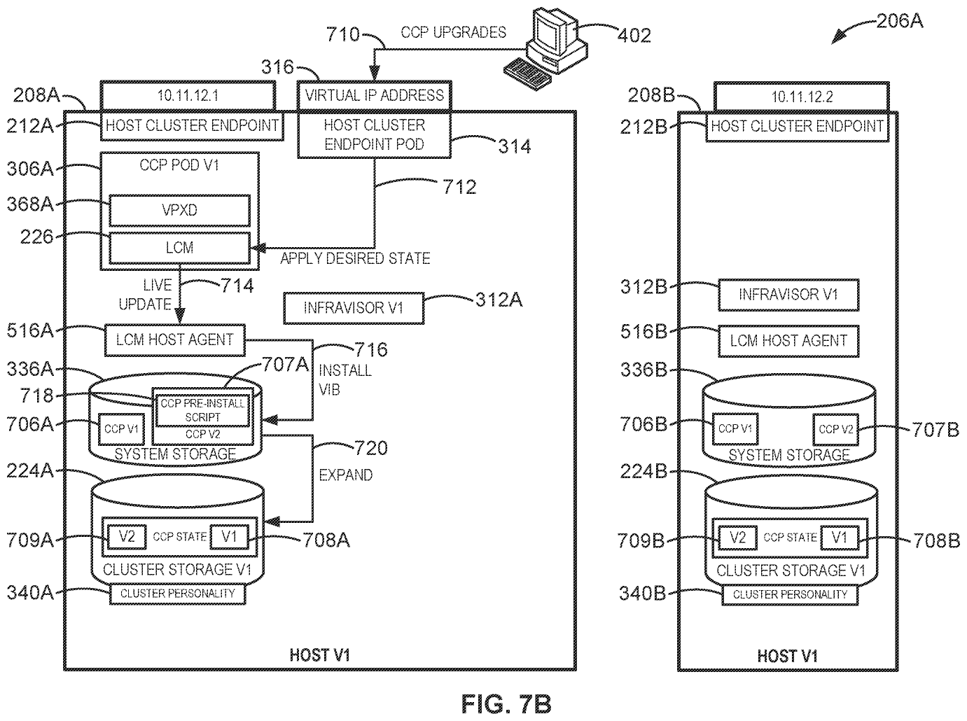

FIG. 6 is a block diagram of an example implementation of the infravisor 312 of FIG. 3B to upgrade autonomous clusters without a loss of availability for the autonomous clusters. The infravisor 600 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the infravisor 600 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The example infravisor 600 includes an example network interface 602, an example upgrade detector 604, an example cluster-control-plane (CCP) manager 606, an example operations scheduler 608, an example shared personality database 610, and an example system storage 612. The example infravisor 600 is a simplification of the example infravisor 312 of FIG. 3B. The components of the example infravisor 312 of FIG. 3B may be arranged or combined to result in the functionality described in connection with FIG. 6. The example infravisor 600 is instantiated on ones of the individual example hosts 208A, 208B, 208C (FIG. 3B).

The example network interface 602 is to receive network communications (e.g., provisioning requests, API requests, etc.) from the example provisioning service 202 (FIG. 3A). A developer such as the example developer 204 of FIGS. 2A-2C may use a computing device to transmit a network communication to the example network interface 602 of the example infravisor 600. The example network interface 602 receives an installation script for the hosts 208A, 208B, 208C (FIG. 3B) of the example first autonomous compute cluster-1 206A (FIG. 2C). The example installation script may include a second version of software (e.g., upgraded software, updated software, etc.) for implementing the hosts 208A, 208B, 208C (FIG. 2C) of the example first autonomous compute cluster-1 206A (FIG. 2C). For example, the network interface 602 stores the installation script in the example system storage 612 of a first autonomous compute cluster of a plurality of autonomous compute clusters. Based on the example of FIG. 3B, if the example second host 208B at the virtual IP address 316 receives the example first provisioning request 364 which includes the installation script, the virtual IP address 316 transmits the example first provisioning request 364 to the example host cluster endpoint pod 314. The example host cluster endpoint pod 314 transmits the example first provisioning request 364 to the example CCP pod 306 (which is associated with the first host 208A). The example CCP pod 306 stores the first provisioning request 364 in the example first cluster storage 224A and the example first system storage 336A. After an update of the CCP pod 306 occurs, and a second version of the CCP pod 306 is in operation, the example network interface 602 is to direct subsequent provisioning requests to the second version of the CCP pod 306.

The example upgrade detector 604 is to detect that an installation script is stored in system storage 612. The example upgrade detector 604 stores a second version of software in the personality database 610. The example upgrade detector 604 removes a first version of software in the personality database 610. In some examples, the personality database 610 is a shared database that is accessible by the other hosts 208A, 208B, 208C.

The example CCP manager 606 is to control execution of the example CCP pod 306 (FIG. 3B). The example CCP manager 606 is to start execution of the CCP pod 306 (FIG. 3B), cease (e.g., stop, pause, cancel) execution of the CCP pod 306 (FIG. 3B), and determine an execution status of the CCP pod 306 (FIG. 3B). For example, the execution status may be an indication that the CCP pod 306 (FIG. 3B) is running. In other examples, the execution status may refer to a version of software (e.g., version one, version two, etc.) that the CCP pod 306 (FIG. 3B) is running. In some examples, the CCP manager 606 is to stop execution of a first CCP pod 306A (FIG. 7B) that is instantiated with a first version of CCP pod software. In such examples, the CCP manager 606 is to start execution (e.g., commencement) of a second CCP pod 306B (FIG. 7C) that is instantiated with a second version of CCP pod software. In some examples, the CCP manager 606 is to confirm that the target state (e.g., desired state, reference state) for the example CCP pod 306 (FIG. 3B) is satisfied. For example, the CCP manager 606 of the example infravisor 600 may access a corresponding configuration specification for the example CCP pod 306 (FIG. 3B). In this example, the configuration specification defines that there is to be one instance of the example CCP pod 306 (FIG. 3B) running on any example host 208A, 208B, 208C (FIG. 3B) in the example first autonomous compute cluster-1 206A. If a first instance of the example CCP pod 306 that is running on the example first host 208A fails, then the example CCP manager 606 starts a second instance of the example CCP pod 306 on the example first host 208A or another host 208B, 208C to satisfy the target state of the configuration specification which specifies that there is to be one instance of the example CCP pod 306 (FIG. 3B) running on any example host 208A, 208B, 208C (FIG. 3B) in the example first autonomous compute cluster-1 206A.

The example operations scheduler 608 is to schedule, start, end, retry, and/or resume operations of the CCP pod 306 (FIG. 3B). In some examples, the operations scheduler 608 determines an importance of the operations (e.g., a high-importance operation, a low-importance operation). In some examples, the operations scheduler 608 determines an execution time to complete the operations (e.g., a short-running operation, a long-running operation). The example operations scheduler 608 uses the importance of the operation and the execution time to complete the operation to determine which operations are ceased (e.g., terminated, stopped), and which operations are scheduled to begin once the second CCP pod 306B (FIG. 7C) is started.

The example personality database 610 is to store a CCP version. In some examples, the personality database 610 is accessible by the hosts 208A, 208B, 208C (FIG. 3B) and is referred to as a shared personality database. Changes made to the example personality database 610 (e.g., such as the first cluster storage 224A) of the first host 208A are reflected in the example personality database 610 (e.g., such as the second cluster storage 224B) of the second host 208B.

The example system storage 612 is to store an installation script. The installation script may include a CCP version, where the CCP version is to be transmitted to the example personality database 610.

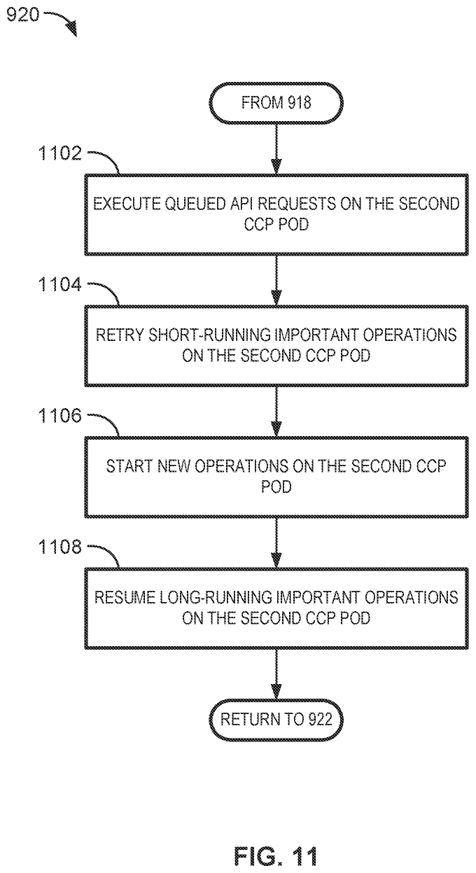

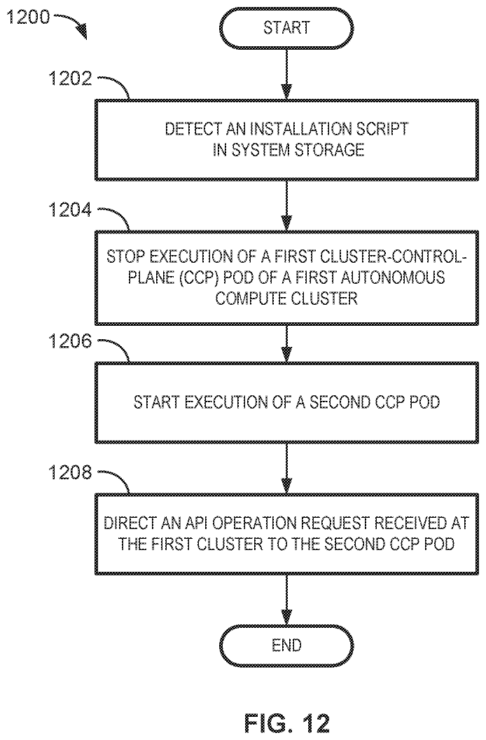

In some examples, the network interface 602 is instantiated by programmable circuitry executing network interface instructions and/or configured to perform operations such as those represented by the flowchart(s) of FIGS. 9 and 12.

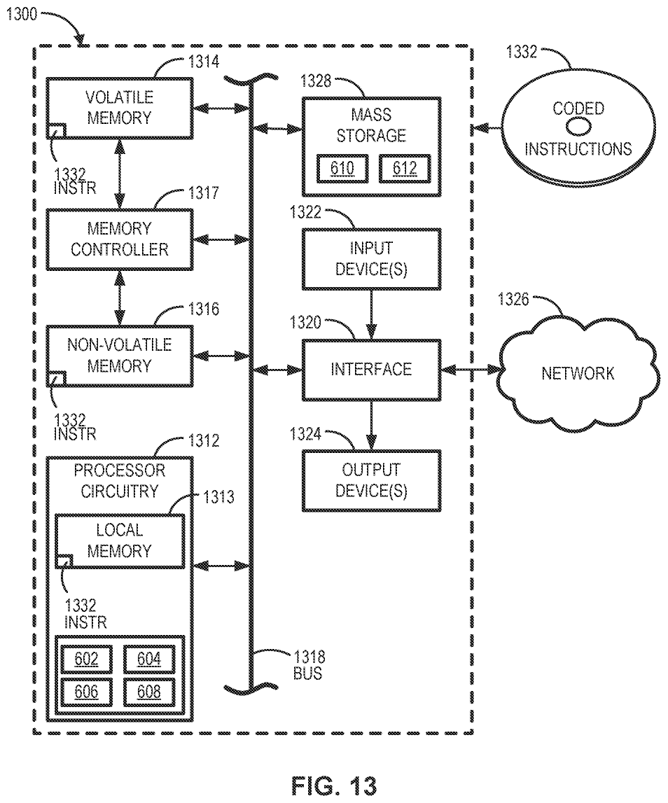

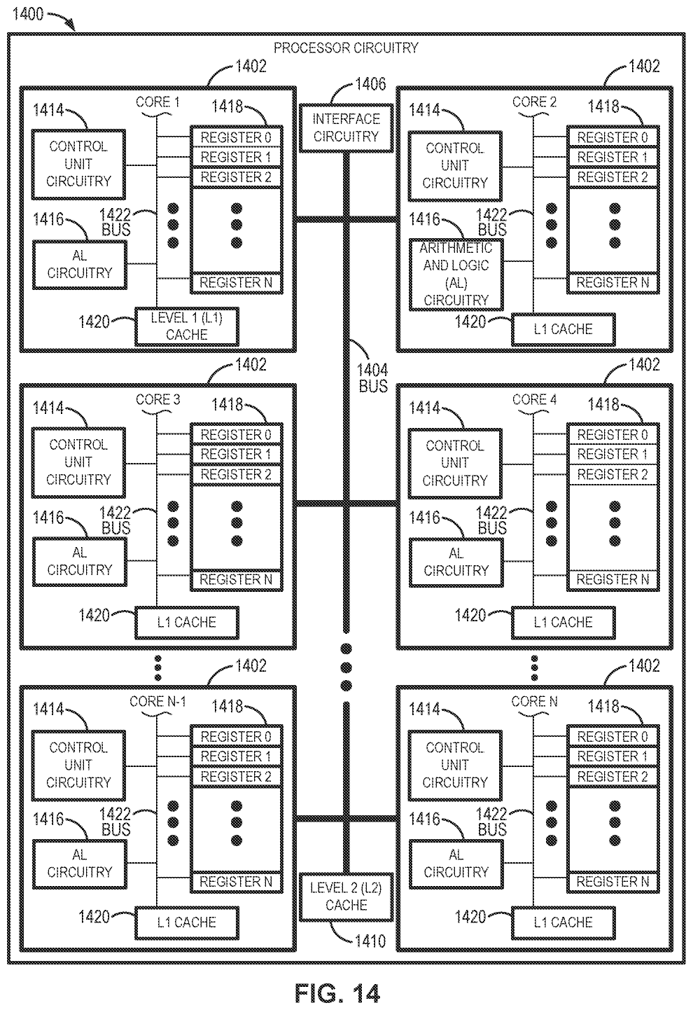

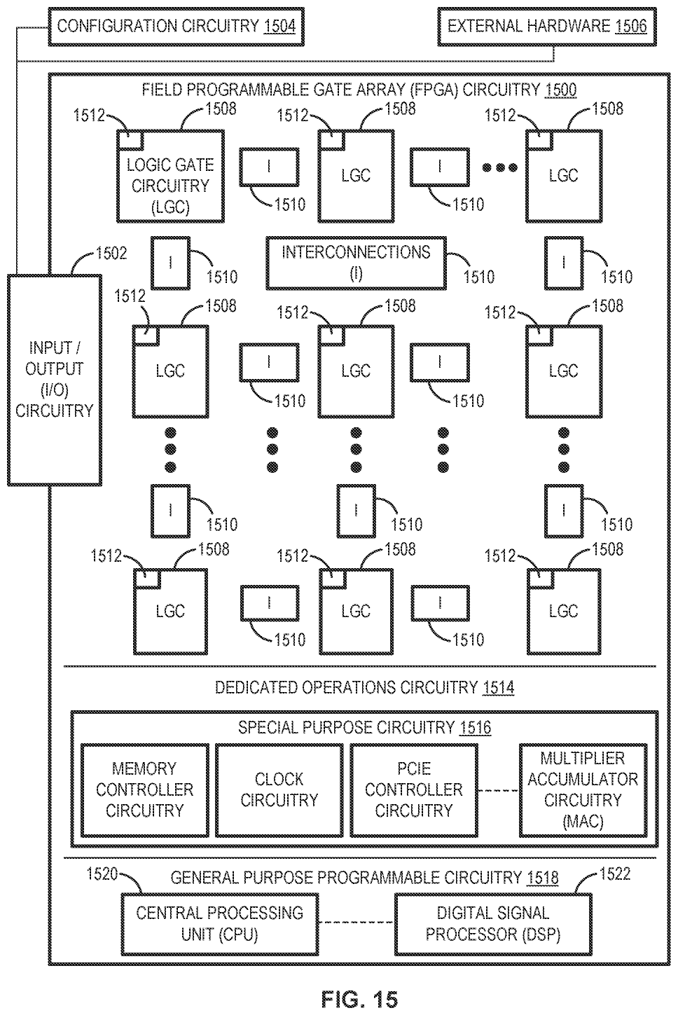

In some examples, the infravisor 600 includes means for receiving and storing an installation script. For example, the means for receiving and storing may be implemented by network interface circuitry such as the network interface 602. In some examples, the network interface 602 may be instantiated by programmable circuitry such as the example programmable circuitry 1312 of FIG. 13. For instance, the network interface 602 may be instantiated by the example microprocessor 1400 of FIG. 14 executing machine executable instructions such as those implemented by at least blocks 902, 904 of FIG. 9, and block 1208 of FIG. 12. In some examples, the network interface 602 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the network interface 602 may be instantiated by any other combination of hardware, software, and/or firmware. For example, the network interface 602 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the upgrade detector 604 is instantiated by programmable circuitry executing upgrade detector instructions and/or configured to perform operations such as those represented by the flowchart(s) of FIGS. 9 and 12.

In some examples, the infravisor 600 includes means for detecting an installation script in system storage. For example, the means for detecting may be implemented by upgrade detector circuitry such as the upgrade detector 604. In some examples, the upgrade detector 604 may be instantiated by programmable circuitry such as the example programmable circuitry 1312 of FIG. 13. For instance, the upgrade detector 604 may be instantiated by the example microprocessor 1400 of FIG. 14 executing machine executable instructions such as those implemented by at least blocks 906, 920, 922, 924 of FIG. 9, and block 1202 of FIG. 12. In some examples, the upgrade detector 604 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the upgrade detector 604 may be instantiated by any other combination of hardware, software, and/or firmware. For example, the upgrade detector 604 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the CCP manager 606 is instantiated by programmable circuitry executing CCP manager instructions and/or configured to perform operations such as those represented by the flowchart(s) of FIGS. 9, 11 and 12.

In some examples, the infravisor 600 includes means for managing a cluster control pod (CCP). For example, the means for managing may be implemented by cluster control pod circuitry such as the CCP manager 606. In some examples, the CCP manager 606 may be instantiated by programmable circuitry such as the example programmable circuitry 1312 of FIG. 13. For instance, the CCP manager 606 may be instantiated by the example microprocessor 1400 of FIG. 14 executing machine executable instructions such as those implemented by at least blocks 908, 916, 918 of FIG. 9, and block 1102 of FIG. 11, and at least blocks 1204, 1206 of FIG. 12. In some examples, the CCP manager 606 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the CCP manager 606 may be instantiated by any other combination of hardware, software, and/or firmware. For example, the CCP manager 606 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the operations scheduler 608 is instantiated by programmable circuitry executing operations scheduler instructions and/or configured to perform operations such as those represented by the flowchart(s) of FIGS. 9, 10, and 11.

In some examples, the infravisor 600 includes means for scheduling operations of a cluster control pod (CCP). For example, the means for scheduling may be implemented by operations schedule circuitry such as the operations scheduler 608. In some examples, the operations scheduler 608 may be instantiated by programmable circuitry such as the example programmable circuitry 1312 of FIG. 13. For instance, the operations scheduler 608 may be instantiated by the example microprocessor 1400 of FIG. 14 executing machine executable instructions such as those implemented by at least blocks 910, 912, 914, of FIG. 9, at least blocks 1002, 1004, 1006, 1008, 1010, 1012, and 1014 of FIG. 10, and at least blocks 1104, 1106, and 1108 of FIG. 11. In some examples, the operations scheduler 608 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the operations scheduler 608 may be instantiated by any other combination of hardware, software, and/or firmware. For example, the operations scheduler 608 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the infravisor 312 of FIG. 3B is illustrated in FIG. 6, one or more of the elements, processes, and/or devices illustrated in FIG. 6 may be combined, divided, re-arranged, omitted, eliminated, and/or implemented in any other way. Further, the example network interface 602, the example upgrade detector 604, the example CCP manager 606 and the example operations scheduler 608, and/or, more generally, the example infravisor 312 of FIG. 3B, may be implemented by hardware alone or by hardware in combination with software and/or firmware. Thus, for example, any of the example network interface 602, the example upgrade detector 604, the example CCP manager 606, and the example operations scheduler 608, and/or, more generally, the example infravisor 312, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example infravisor 312 of FIG. 3B may include one or more elements, processes, and/or devices in addition to, or instead of, those illustrated in FIG. 3B, and/or may include more than one of any or all of the illustrated elements, processes and devices.

FIG. 7A is an example environment of a first autonomous compute cluster-1 206A with a first host 208A and a second host 208B at a first time. The example of FIG. 7A includes a client computing device 402 (e.g., customer computing device) which is to communicate with the example virtual IP address 316 of the first host 208A. The example first host 208A has an example first host cluster endpoint 212A of 10.11.12.1. The example second host 208B has a second host cluster endpoint 212B of 10.11.12.2. The example first host 208A includes an example first CCP pod 306A. The example first CCP pod 306A is a first version (“V1”) at the first time of FIG. 7A. The example first CCP pod 306A includes a first instance of an example virtual provisioning cross cluster daemon (VPXD) 368A and the example LCM 226 (e.g., lifecycle manager). The example first host 208A includes a first infravisor 312A (e.g., a first instance of the infravisor 600 of FIG. 6), a first LCM host agent 516A, a first system storage 336A, and a first cluster storage 224A.

The example first system storage 336A (e.g., the system storage 612 of FIG. 6) includes a first instance of a first version of CCP software instructions 706A. The example first cluster storage 224A (e.g., the personality database 610 of FIG. 6) includes a first version of a first CCP state 708A and a first cluster personality data 340A. Similarly, the example second host 208B includes a second infravisor 312B (e.g., a second instance of the infravisor 600 of FIG. 6), a second LCM host agent 516B, a second system storage 336B, and a second cluster storage 224B. The example second system storage includes a second instance of the first version of CCP software instructions 706B. The example second cluster storage 224B includes a second instance of a first version of a second CCP state 708B.

At operation 702, the example client computing device 402 sends a virtual machine (VM) provisioning request to the example virtual IP address 316. The example virtual IP address 316 transmits the request to the example host cluster endpoint pod 314. At operation 704, the example host cluster endpoint pod 314 transmits the VM provisioning request to the first CCP pod 306A. The example VPXD 368A of the first CCP pod 306A receives the VM provisioning request. The example VPXD 368A provisions a virtual machine based on the version of the CCP state 708 which is stored in the example cluster storage 224A. In the example of FIG. 7A, the CCP state 708 is a first CCP state 708A.

FIG. 7B is an example environment of a first autonomous compute cluster-1 206A with the first host 208A and the second host 208B at a second time. At the second time, and at operation 710, the example client computing device 402 sends a CCP upgrade request to the example virtual IP address 316 of the first host 208A. The example virtual IP address 316 transmits the CCP upgrade request to the example host cluster endpoint pod 314. At operation 712, the example host cluster endpoint pod 314 applies the desired configuration state (e.g., target configuration state, reference configuration state) to the first CCP pod 306A. The desired configuration state includes installation instructions 718 (e.g., a pre-install script) for a second version of CCP software instructions 707A. The example host cluster endpoint pod 314 applies the desired configuration state by transmitting the desired configuration state to the LCM 226 of the first CCP pod 306A.

At operation 714, the LCM 226 of the first CCP pod 306A performs a live update by directing the CCP upgrade request to the first LCM host agent 516A. The example first LCM host agent 516A, at operation 716, installs one or more installation files (e.g., installation bundle) by storing the second version of CCP software instructions 707A in the first system storage 336A. In some examples, the one or more installation files may be implemented used a virtual infrastructure bundle (VIB) (e.g., a VMware® vSphere Installation Bundle) which bundles software to be installed on a host. The second version of CCP software instructions 707A includes installation instructions 718 (e.g., CCP pre-install script). At operation 720, the example first infravisor 312A expands (e.g., executes, runs) the second version of CCP software instructions 707A to generate a second CCP state 709A in the first cluster storage 224A. Concurrently (e.g., in parallel) with the installation at operation 716, the second system storage 336B of the second host 208B includes a second instance of the second version of CCP software instructions 707B. The example second LCM host agent 516B stores the example second instance of the second version of the CCP software instructions 707B in the example second system storage 336B. Concurrently (e.g., in parallel) with the expansion at operation 720, the example second infravisor 312B of the example second host 208B expands a second instance of the second CCP state 709B in the second cluster storage 224B of the second host 208B.

FIG. 7C is an environment diagram of a first autonomous cluster with a first host 208A and a second host 208B at a third time. Operation 720 is shown in FIG. 7B and is shown merely for continuity in FIG. 7C. At operation 720, the example first infravisor 312A expands (e.g., executes, runs) the second version of CCP software instructions 707A to generate a second CCP state 709A in the first cluster storage 224A.

At operation 722, the example first infravisor 312A detects the second version of CCP software instructions 707A. The example first infravisor 312A determines that the second version of CCP software instructions 707A is different from the first version of CCP software instructions 706A, and determines to update the first CCP pod 306A.

At operation 724, the example first infravisor 312A stops the execution of the first CCP pod 306A.

At operation 726, the example first infravisor 312A starts the execution of a second CCP pod 306B. The example second CCP pod 306B runs the second version of CCP software instructions 707A.

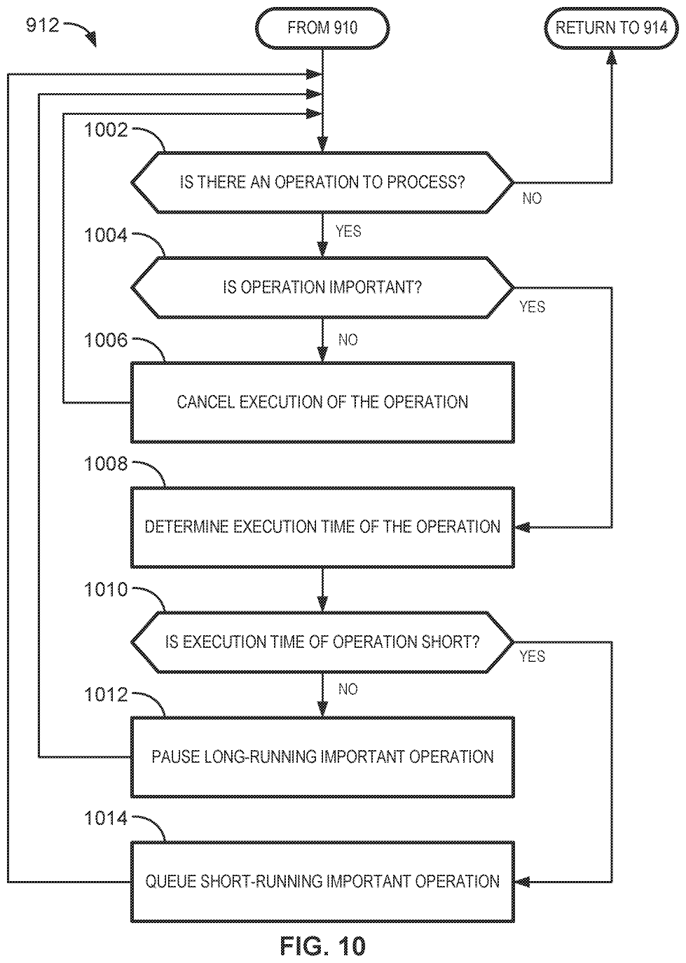

At operation 728, the example first infravisor 312A performs a switchover from the first CCP pod 306A to the second CCP pod 306B. The example first CCP pod 306A is illustrated with dashed lines to illustrate that the first CCP pod 306A is no longer present in the environment after the switchover. After the switchover is completed at operation 728, requests that are received at the virtual IP address 316 (e.g., such as the virtual machine provisioning request of operation 732) are directed to the example second CCP pod 306B. FIGS. 8, 10, and 11 provide additional details on scheduling requests received at the virtual IP address 316 during the switchover process.

At operation 730, the example second CCP pod 306B loads the second CCP state 709A (e.g., the second version of the desired configuration state) from the first cluster storage 224A. The example second CCP pod 306B includes a second instance of an example virtual provisioning cross cluster daemon (VPXD) 368B), and a second LCM 226B. The example second instance of the example VPXD 368B may be updated or upgraded from the first instance of the example VPXD 368A. The example LCM 226B may be updated or upgraded from the LCM 226A.

At operation 732, the example client computing device 402 sends a virtual machine provisioning request. The example virtual IP address 316 receives the virtual machine provisioning request and transmits the request to the host cluster endpoint pod 314. The example host cluster endpoint pod 314 rather than directing the request to the first CCP pod 306A, directs the request to the second CCP pod 306B at operation 734.

At operation 736, the example second CCP pod 306B uses the example second LCM 226B to contract (e.g., remove, delete) the example first CCP state 708A from the first cluster storage 224A. The example second CCP pod 306B then provisions the virtual machine as described from the provisioning request received at operation 732.

FIG. 8 is an example timing diagram 800 for operations received at the first autonomous compute cluster-1 206A (FIG. 2C). The example cluster non-disruptive upgrade 802 is illustrated by the first timeline. The example CCP failover 804 is illustrated by the second timeline. In the illustrated example, the second timeline is shorter than the first timeline. The example cluster non-disruptive upgrade 802 has a start point 806 (e.g., “START CLUSTER NON-DISRUPTIVE UPGRADE”) and an endpoint 838 (“END CLUSTER NON-DISRUPTIVE UPGRADE”). The example CCP failover 804 includes a start point 812 (e.g., “START CCP FAILOVER”), a first progress point 824 (e.g., “OLD CCP STOPPED”), a second progress point 826 (e.g., “NEW CCP STARTED”), and an end point 828 (e.g., “END CCP FAILOVER”).

Before the start point 806 of the example cluster non-disruptive upgrade 802, short-running operations (OPS) 808 are being executed and long-running operations (OPS) 810 are being executed. During such executions, the start point 806 of the example cluster non-disruptive upgrade 802 begins. The example infravisor 600 (FIG. 6), after beginning the non-disruptive upgrade of the first autonomous compute cluster-1 206A (FIG. 2C), starts the CCP failover 804 at the start point 812. The example operations scheduler 608 of the infravisor 600 (FIG. 6) schedules the operations.

During the CCP failover 804, new API requests 814 that would have been directed to the first CCP pod 306A (FIG. 7C) for execution are instead queued by the example operations scheduler 608 (FIG. 6). The example operations scheduler 608 (FIG. 6) queues the example new API requests 814 for execution on a subsequent CCP pod such as the example second CCP pod 306B (FIG. 7C). The example operations scheduler 608 (FIG. 6) divides (e.g., distinguishes, separates) the short-running operations 808 by importance into short-running business-critical operations 816 and short-running non-business-critical operations 820. The example operations scheduler 608 (FIG. 6) queues the short-running business-critical operations 816 and cancels the short-running non-business-critical operations 820. The example operations scheduler 608 (FIG. 6) divides the long-running operations 810 into long-running business-critical operations 818 and long-running non-business-critical operations 822. The example operations scheduler 608 (FIG. 6) pauses the long-running business-critical operations 818 and cancels the long-running non-business-critical operations 822. In some examples, the operations scheduler 608 (FIG. 6) determines an importance value of the specific operations and compares the first importance value of a first operation with the second importance value of a second operation to determine which operation has more importance. In some examples, an importance value threshold is specified by the example workstation 201 (FIGS. 2A-2C) where operations that exceed the importance value threshold are classified as important. These example importance values may be determined based on an operation type of the operation. For example, operation types may include business-critical operation type, routine maintenance operation type, optional service operation type, etc.

At the first progress point 824 after the operations of the first CCP pod 306A of FIG. 7C have been scheduled, the example CCP manager 606 (FIG. 6) stops the execution of the first version of the first CCP pod 306A of FIG. 7C. After the first progress point 824, the example operation scheduler 608 (FIG. 6) continues to queue new API requests 814 (e.g., new operations). At the second progress point 826, the example CCP manager 606 starts the second CCP pod 306B of FIG. 7C (e.g., the upgraded CCP pod, the updated CCP pod). After the second CCP pod 306B (FIG. 7C) is running, the example CCP manager 606 ends the CCP failover at the endpoint 828.

After the CCP failover 804 is completed, the new API requests 814 are referred to as queued API requests 830, the short-running business-critical operations 816 are referred to as short-running business-critical operations 832, and the long-running business-critical operations 818 are referred to as long-running business-critical operations 836. The changed reference numerals reflect the status that the second CCP pod 306B is managing the operations. During the CCP failover 804, the short-running non-business-critical operations 820 and the long-running non-business critical operations 822 were canceled and thus are not listed for execution on the example second CCP pod 306B.

After the CCP failover 804 is completed, the example second CCP pod 306B executes the queued API requests 830. The example second CCP pod 306B retries the short-running business-critical operations 832. The example second CCP pod 306B starts new operations 834. The new operations 834 are directed to the first CCP pod 306A. However, after the example first CCP pod 306A is gracefully stopped, the new operations 834 are directed to the second CCP pod 306B. The example second CCP pod 306B resumes the long-running business-critical operations 836. At some later point in time, after monitoring the second CCP pod 306B, the example CCP manager 606 (FIG. 6) ends the cluster non-disruptive upgrade 802 at endpoint 838.

Flowchart(s) representative of example machine readable instructions, which may be executed by programmable circuitry to implement and/or instantiate the infravisor 312 of FIG. 3B and/or representative of example operations which may be performed by programmable circuitry to implement and/or instantiate the infravisor 312 of FIG. 3B, are shown in FIGS. 9-12. The machine readable instructions may be one or more executable programs or portion(s) of one or more executable programs for execution by programmable circuitry such as the programmable circuitry 1312 shown in the example programmable circuitry platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device.

Similarly, the non-transitory computer readable storage medium may include one or more mediums. Further, although the example program is described with reference to the flowchart(s) illustrated in FIGS. 9-12, many other methods of implementing the example infravisor 312 may alternatively be used. For example, the order of execution of the blocks of the flowchart(s) may be changed, and/or some of the blocks described may be changed, eliminated, or combined.

Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-12 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to upgrade the CCP pod 306 (FIG. 3B). The example machine-readable instructions and/or the example operations 900 of FIG. 9 begin at block 902, at which the example network interface 602 (FIG. 6) receives an installation script. For example, the network interface 602 (FIG. 6) may receive an installation script by using virtual IP address 316 (FIG. 3B) and the host cluster endpoint pod 314 (FIG. 3B). The installation script includes a second version of software for implementing a CCP pod 306 (FIG. 3B). In some examples, the installation script is included in an API request to apply an updated cluster personality (e.g., cluster desired state, cluster reference state, cluster target state, etc.).

In some examples, before the example operations 900 of FIG. 9 begin, an API request to provision a virtual machine is sent to the example network interface 602 (FIG. 6). This API request to provision a virtual machine is forwarded to the example first CCP pod 306A (FIG. 7A) which is the active CCP pod 306 (FIG. 3B). In such examples, the first CCP pod 306A (FIG. 7A) then provisions the virtual machine.

At block 904, the example network interface 602 (FIG. 6) stores the installation script in system storage 612 (FIG. 6). For example, the network interface 602 (FIG. 6) may store the installation script in first system storage 336A of FIG. 7A (e.g., local system storage) of a first host 208A (FIG. 7A) of the example first autonomous compute cluster-1 206A (FIG. 2C). For example, the network interface 602 (FIG. 6) may store the installation script in first system storage 336A of FIG. 7A by using the example first CCP pod 306A of FIG. 7A. In some examples, by storing the installation script in the first system storage 336A of FIG. 7A, the network interface 602 (FIG. 6) stages the installation script in the first system storage 336A to realize the target state of the first autonomous compute cluster-1 206A (FIG. 7A). In such examples, the LCM 226A (FIG. 7A) instructs the example LCM host agent 516A to install the already staged (e.g., previously staged) installation (e.g., VIB file).

At block 906, the example upgrade detector 604 (FIG. 6) detects the installation script in the system storage 612 (FIG. 6). For example, the upgrade detector 604 (FIG. 6) may detect the installation script in the system storage 612 (FIG. 6) by checking for changes to a specific directory in the example file system. In some examples, after detection of the installation script in the system storage 612 (FIG. 6) by the example upgrade detector 604 (FIG. 6), the example upgrade detector 604 (FIG. 6) installs the installation script. During installation, the example upgrade detector 604 (FIG. 6) invokes the installation script to extend the CCP state schema to comply with the first version of the CCP state and the second version of the CCP state. After installation, the example upgrade detector 604 (FIG. 6) detects that the second version of the CCP state is installed on the local system storage of the first host 208A (FIG. 7A) and verifies that the second version of the CCP state is distributed to the other hosts 208B, 208C (FIG. 3B) within the example first autonomous compute cluster-1 206A (FIG. 7A). In the example of FIG. 7A, the second version of the CCP state is distributed to the example second host 208B (FIG. 7A).

At block 908, the example CCP manager 606 (FIG. 6) determines if the first CCP pod 306A (FIG. 7B) is currently active. For example, the CCP manager 606 (FIG. 6) may determine that the first CCP pod 306A (FIG. 7B) is currently active by determining if API requests are being directed to the first CCP pod 306A (FIG. 7B). The example CCP manager 606 (FIG. 6) determines if the first CCP pod 306A (FIG. 7B) is active to begin the graceful stopping process (e.g., seamless transition process). In response to determining that the first CCP pod 306A (FIG. 7B) is currently active (block 908: YES), control advances to block 910. Alternatively, in response to determining that the first CCP pod 306A (FIG. 7B) is not currently active (block 908: NO), control advances to block 918.

At block 910, the example operations scheduler 608 (FIG. 6) determines the operations that the first CCP pod 306A (FIG. 7B) is executing. For example, the operations scheduler 608 (FIG. 6) determines the operations by generating a list of the operations or querying the first CCP pod 306A (FIG. 7B) for the operations.

At block 912, the example operations scheduler 608 (FIG. 6) classifies the operations of the first CCP pod 306A (FIG. 7B). For example, the operations scheduler 608 (FIG. 6) may classify the operations by determining the importance of the operations (e.g., business-critical, non-business-critical) and the execution time to complete the operations (e.g., short-running, long-running). Example instructions and/or operations that may be used to implement block 912 are described below in connection with FIG. 10.

At block 914, the example operations scheduler 608 (FIG. 6) schedules the operations of the first CCP pod 306A (FIG. 7B). For example, the operations scheduler 608 (FIG. 6) may schedule the short-running business-critical operations to be retried by the example second CCP pod 306B (FIG. 7C), the long-running business-critical operations to be paused at the first CCP pod 306A (FIG. 7B) and resumed at the second CCP pod 306B (FIG. 7C), and the non-business-critical operations to be canceled. In some examples, the operations scheduler 608 (FIG. 6) prepares the user sessions (e.g., active tasks, active property collector sessions, etc.) to survive the restart of the example first CCP pod 306A (FIG. 7B). In such examples, the second CCP pod 306B (FIG. 7C) can resume the user session without a client disruption. In some examples, the LCM 226 (FIG. 7B) can pause during the graceful stopping and resume after the cross cluster control plane is upgraded on the example second CCP pod 306B (FIG. 7C).

At block 916, the example CCP manager 606 (FIG. 6) ceases (e.g., stops) execution of the first CCP pod 306A (FIG. 7C). For example, the CCP manager 606 (FIG. 6) may cease execution of the first CCP pod 306A (FIG. 7C) by removing the first CCP pod 306A (FIG. 7C) from the first autonomous compute cluster-1 206A (FIG. 7C). In some examples, after the first CCP pod 306A (FIG. 7C) is stopped, the example network interface 602 (FIG. 6) holds new incoming API requests and redirects the new incoming API requests to the second CCP pod 306B (FIG. 7C) after the target state (e.g., cluster personality) is restored from the personality database 610 (FIG. 6) and the second CCP pod 306B (FIG. 7C) is operational.

At block 918, the example CCP manager 606 (FIG. 6) starts execution of the second CCP pod 306B (FIG. 7C). For example, the CCP manager 606 (FIG. 6) may start execution of the second CCP pod 306B (FIG. 7C) by transferring the scheduled operations from the first CCP pod 306A (FIG. 7C) to the second CCP pod 306B (FIG. 7C). In some examples, the CCP manager 606 (FIG. 6) starts the second CCP pod 306B (FIG. 7C) by loading the second target state (e.g., second cluster personality) from the personality database 610 (FIG. 6).

At block 920, the example CCP manager 606 (FIG. 6) causes the second CCP pod 306B (FIG. 7C) to execute the remaining operations from the first CCP pod 306A (FIG. 7C). For example, the CCP manager 606 may instruct the example second CCP pod 306B (FIG. 7C) to execute and process the operations. In some examples, the second CCP pod 306B (FIG. 7C) resumes and/or retries the operations. In some examples, the graceful stopping process (e.g., failover, switchover, seamless transition) occurs in thirty seconds which masks (e.g., obscures) the complications of switching from the first CCP pod 306A (FIG. 7C) to the second CCP pod 306B (FIG. 7C) to a user account.

At block 922, the example upgrade detector 604 (FIG. 6) stores a second configuration state of the second CCP pod 306B (FIG. 7C) in a shared personality database 610 (FIG. 6). For example, the upgrade detector 604 (FIG. 6) may store the second configuration state of the second CCP pod 306B (FIG. 7C) in a shared personality database 610 (FIG. 6) that is accessible by the hosts 208A, 208B, 208C (FIG. 2B) of the first autonomous compute cluster-1 206A (FIG. 2B).

At block 924, the example upgrade detector 604 (FIG. 6) removes the first configuration state of the first CCP pod 306A (FIG. 7C) from the shared personality database 610 (FIG. 6). For example, the upgrade detector 604 (FIG. 6) may remove the first version of the software in a shared personality database 610 (FIG. 6) by deleting the first configuration state. After the first configuration state is deleted, the shared personality database 610 (FIG. 6) still includes the second configuration state. As such, subsequent provisioning of virtual machines may use the second configuration state. The instructions 900 end.

FIG. 10 is a flowchart representative of example machine readable instructions and/or example operations 912 that may be executed, instantiated, and/or performed by programmable circuitry to implement the operation scheduler 608 (FIG. 6) of the example infravisor 600 (FIG. 6) to classify the operations of the first CCP pod 306A (FIG. 7A). The example machine-readable instructions and/or the example operations 912 of FIG. 10 may be used to implement block 912 of FIG. 9. The example machine-readable instructions and/or the example operations 912 of FIG. 10 begin at block 1002, at which the example operations scheduler 608 (FIG. 6) determines if there is an operation to process. For example, the operations scheduler 608 (FIG. 6) may determine if there is an operation by receiving a list of operations currently in process from the first CCP pod 306A (FIG. 7A). In response to determining that there is not another operation to process (block 1002: NO), control returns to block 914 of FIG. 9. Alternatively, in response to determining that there is another operation to process (block 1002: YES), control advances to block 1004.

At block 1004, the example operations scheduler 608 (FIG. 6) determines if the operation is characterized as important. For example, the example operations scheduler 608 (FIG. 6) may determine an operation is important by determining an operation type of the operation. For example, operation types may include business-critical operation type, routine maintenance operation type, optional service operation type, etc. In such examples, a business-critical operation type may satisfy an importance threshold so that a corresponding operation is characterized as important. Some examples of business-critical operations include provisioning a workload, performing admission control, performing initial virtual machine placement, and performing power state changes. In response to determining that an operation is important (block 1004: YES), control advances to block 1008. Alternatively, in response to determining that an operation is not important (block 1004: NO), control advances to block 1006.

At block 1006, the example operations scheduler 608 (FIG. 6) cancels the execution of the operation that is not important. For example, the example operations scheduler 608 (FIG. 6) may cancel (e.g., terminate, end, etc.) the short-running non-business-critical operations and the long-running non-business-critical operations. After block 1006, control returns to block 1002.

At block 1008, the example operations scheduler 608 (FIG. 6) determines the execution time of the operation. For example, the operations scheduler 608 (FIG. 6) may use a timer to determine the execution time of the operation. In some examples, the operations scheduler 608 (FIG. 6) may use a list to determine an average execution time for the operation.

At block 1010, the example operations scheduler 608 (FIG. 6) determines if the execution time of the operation is short. In some examples, an execution time of an operation is characterized as short if the operation can be completed in less than one second. In other examples, any other suitable duration may be used. In some examples, the short operations are read-only operations. In response to determining that the execution time of the operation is short (block 1010: YES), control advances to block 1014. Alternatively, in response to determining that the execution time of the operation is not short (block 1010: NO), the execution time of the operation is characterized as long, and control advances to block 1012.

At block 1012, the example operations scheduler 608 (FIG. 6) pauses the long-running important operation (e.g., the long-running business-critical operation). After block 1012, control advances to block 1002.

At block 1014, the example operations scheduler 608 (FIG. 6) queues the short-running important operation (e.g., the short-running business-critical operation). After block 1014, control returns to block 1002.

When there is no additional operation in process at block 1002, the example machine-readable instructions and/or the example operations 912 end, and control returns to block 914 of FIG. 9.

FIG. 11 is a flowchart representative of example machine readable instructions and/or example operations 920 that may be executed, instantiated, and/or performed by programmable circuitry to implement the operations scheduler 608 (FIG. 6) of the example infravisor 600 (FIG. 6) to execute remaining operations from the first CCP pod 306A (FIG. 7C) on the second CCP pod 306B (FIG. 7C). The example machine-readable instructions and/or the example operations 920 of FIG. 11 may be used to implement block 920 of FIG. 9. The example machine-readable instructions and/or the example operations 920 of FIG. 11 begin at block 1102, at which the example operations scheduler 608 (FIG. 6) executes queued API requests on the second CCP pod 306B (FIG. 7C). The example queued API requests are received after cessation of the first CCP pod 306A (FIG. 7C).

At block 1104, the example operations scheduler 608 (FIG. 6) retries the short-running important operations on the second CCP pod 306B (FIG. 7C). In some examples, during the time after CCP failover is started and before the first CCP pod 306A (FIG. 7B) is stopped, the operations scheduler 608 (FIG. 6) schedules the short-running business-critical operations 832 (FIG. 8) to be retried by the second CCP pod 306B (FIG. 7C). In such examples, the operations scheduler 608 (FIG. 6) adds the short-running business-critical operations 832 (FIG. 8) to a list for future retry. The short-running business-critical operations 832 (FIG. 8) are added to an execution queue before processing, and the execution queue is transformed into a persistent retry queue which can be accessed by the second CCP pod 306B (FIG. 7C). In some examples, the short-running business-critical operations 832 (FIG. 8) are designed to be highly available and idempotent. As used herein, retry means that the operation is first queued and then started. In some examples, after a failure of the to execute the short-running business-critical operations 832 (FIG. 8) in association with the first CCP pod 306A (FIG. 7C) and after the commencement (e.g., start, beginning, etc.) of the second CCP pod 306B (FIG. 7C), the example operations scheduler 608 (FIG. 6) retries execution of the short-running business-critical operations 832 (FIG. 8) in association with the second CCP pod 306B (FIG. 7C).

At block 1106, the example operations scheduler 608 (FIG. 6) starts new operations on the second CCP pod 306B (FIG. 7C). The new operations are received by the example network interface 602 (FIG. 6), but instead of being directed to the example first CCP pod 306A (FIG. 7C), the network interface 602 (FIG. 6) directs the new operations to the second CCP pod 306B (FIG. 7C). In some examples, the operations scheduler 608 (FIG. 6) schedules the operations for execution by the second CCP pod 306B (FIG. 7C).

At block 1108, the example operations scheduler 608 (FIG. 6) resumes the long-running important operations of the second CCP pod 306B (FIG. 7C). In some examples, the operations scheduler 608 (FIG. 6) schedules the long-running business-critical operations to resume execution by the second CCP pod 306B (FIG. 7C). The example machine-readable instructions and/or the example operations 920 of FIG. 11 end, and control returns to block 922 of FIG. 9.

FIG. 12 is a flowchart representative of example machine readable instructions and/or example operations 1200 that may be executed, instantiated, and/or performed by programmable circuitry to implement the infravisor 600 (FIG. 6) to upgrade a CCP pod 306 (FIG. 3B) of first autonomous compute cluster-1 206A (FIG. 2C) from a first version to a second version. The example machine-readable instructions and/or the example operations 1200 of FIG. 12 begin at block 1202, at which the example upgrade detector 604 (FIG. 6) detects an installation script in system storage. For example, the upgrade detector 604 (FIG. 6) may detect an installation script in system storage that includes a second version of CCP instructions.

At block 1204, the example CCP manager 606 (FIG. 6) stops execution of a first cluster-control-plane (CCP) pod 306A (FIG. 7C) of a first autonomous compute cluster-1 206A (FIG. 2C). The example first CCP pod 306A (FIG. 7C) is instantiated with a first version of CCP pod software.

At block 1206, the example CCP manager 606 (FIG. 6) starts execution of a second CCP pod 306B (FIG. 7C). The example second CCP pod 306B (FIG. 7C) is instantiated with a second version of CCP pod software.

At block 1208, the example network interface 602 (FIG. 6) directs an API operation request received at the first autonomous compute cluster-1 206A (FIG. 2C) to the second CCP pod 306B (FIG. 7C). For example, the network interface 602 (FIG. 6) directs the API operation request (e.g., a provisioning request) received at the first autonomous compute cluster-1 206A (FIG. 2C) to the second CCP pod 306B (FIG. 7C) without directing the API operation request to the first CCP pod 306A (FIG. 7C). The machine-readable instructions and/or the example operations 1200 end.

FIG. 13 is a block diagram of an example programmable circuitry platform 1300 structured to execute and/or instantiate the example machine-readable instructions and/or the example operations of FIGS. 9-12 to implement the infravisor 312 of FIG. 3B. The programmable circuitry platform 1300 can be, for example, a server, a personal computer, a workstation, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example network interface 602, the example upgrade detector 604, the example CCP manager 606, and the example operations scheduler 608.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 9-12, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIG. 2 as logic circuits to perform operations corresponding to those machine readable instructions. In some such examples, the circuitry of FIG. 2 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowchart(s) of FIGS. 9-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1500 may be configured and/or structured to effectively instantiate some or all of the operations/functions corresponding to the machine readable instructions of the flowchart(s) of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowchart(s) of FIGS. 9-12 to perform first operation(s)/function(s), the FPGA circuitry 1500 of FIG. 15 may be configured and/or structured to perform second operation(s)/function(s) corresponding to a second portion of the machine readable instructions represented by the flowcharts of FIGS. 9-12, and/or an ASIC may be configured and/or structured to perform third operation(s)/function(s) corresponding to a third portion of the machine readable instructions represented by the flowcharts of FIGS. 9-12.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

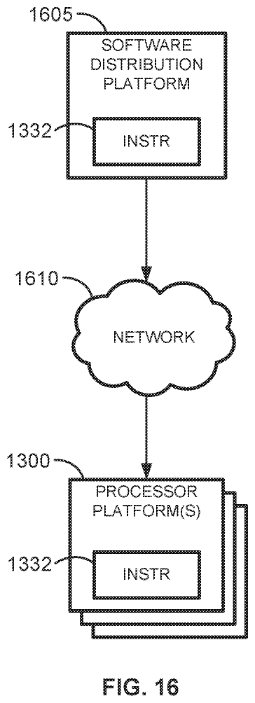

A block diagram illustrating an example software distribution platform 1605 to distribute software such as the example machine readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions of FIGS. 9-12, may be downloaded to the example programmable circuitry platform 1300, which is to execute the machine readable instructions 1332 to implement the infravisor. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to an occurrence being within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that upgrade a CCP pod of an autonomous cluster while keeping the autonomous cluster available for provisioning requests. Disclosed systems, apparatus, articles of manufacture, and methods improve the efficiency of using a computing device by reducing failed operations which are sent to a first CCP pod, by directing the operations to a second CCP pod which will execute the operations. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to perform lifecycle management of autonomous clusters in a virtual computing environment are disclosed herein. Further examples and combinations thereof include the following: Example 1 includes a system including machine readable instructions, programmable circuitry to at least one of instantiate or execute the machine readable instructions to detect an installation script, the installation script including a second version of software in system storage of a first cluster of a plurality of clusters, a first version of the software installed in the first cluster, and after execution of the first version of the software by a first cluster control plane (CCP) pod is stopped, start execution of a second CCP pod, the second CCP pod instantiated with the second version of the software, and interface circuitry to direct an application programming interface (API) operation request received at the first cluster to the second CCP pod without directing the API operation request to the first CCP pod.

Example 2 includes the system of example 1, wherein the API operation request is a provisioning request.

Example 3 includes the system of example 1, wherein the programmable circuitry is to instruct the second CCP pod to store the second version of the software in a personality database, and remove the first version of the software from the personality database.

Example 4 includes the system of example 1, wherein the programmable circuitry is to instantiate a third CCP pod belonging to a second cluster based on the second version of the software that is stored in a personality database of the second cluster.

Example 5 includes the system of example 1, wherein after the execution of the first version of the software by the first CCP pod is stopped, the programmable circuitry is to upgrade the first cluster to execute the second version of the software.

Example 6 includes the system of example 1, wherein before the execution of the first version of the software by the first CCP pod is stopped, the programmable circuitry is to schedule operations to be executed by the first CCP pod based on a first execution time of a first operation being shorter than a second execution time of a second operation, and based on a first importance value of a first operation being representing more importance than a second importance value of a second operation.

Example 7 includes the system of example 1, wherein before the execution of the first version of the software by the first CCP pod is stopped, the programmable circuitry is to queue first operations, the first operations corresponding to a first execution time and a first importance value, and after a failure to execute the first operations in association with the first CCP pod and after commencement of the second CCP pod, retry execution of the first operations in association with the second CCP pod.

Example 8 includes the system of example 1, wherein before the execution of the first version of the software by the first CCP pod is stopped, the programmable circuitry is to after an indication that the first CCP pod is to be stopped, and before commencement of the second CCP pod, queue a first operation, and after commencement of the second CCP pod, execute the first operation.

Example 9 includes a non-transitory machine readable storage medium including instructions to cause programmable circuitry to at least detect an installation script, the installation script including a second version of software in system storage of a first cluster of a plurality of clusters, a first version of the software installed in the first cluster, after execution of the first version of the software by a first cluster control plane (CCP) pod is stopped, start a second CCP pod, the second CCP pod instantiated with the second version of the software, and directing an application programming interface (API) operation request received at the first cluster to the second CCP pod without directing the API operation request to the first CCP pod.

Example 10 includes the non-transitory machine readable storage medium of example 9, wherein the API operation request is a provisioning request.

Example 11 includes the non-transitory machine readable storage medium of example 9, wherein the instructions are to cause the programmable circuitry to instruct the second CCP pod to store the second version of the software in a personality database, and remove the first version of the software from the personality database.

Example 12 includes the non-transitory machine readable storage medium of example 9, wherein the instructions are to cause the programmable circuitry to instantiate a third CCP pod belonging to a second cluster based on the second version of the software that is stored in a personality database of the second cluster.

Example 13 includes the non-transitory machine readable storage medium of example 9, wherein after the execution of the first version of the software by the first CCP pod is stopped, the instructions are to cause the programmable circuitry to upgrade the first cluster to execute the second version of the software.

Example 14 includes the non-transitory machine readable storage medium of example 9, wherein before the execution of the first version of the software by the first CCP pod is stopped, the instructions are to cause the programmable circuitry to schedule operations to be executed by the first CCP pod based on a first execution time of a first operation being shorter than a second execution time of a second operation, and based on a first importance value of the first operation representing more importance than a second importance value of the second operation.

Example 15 includes the non-transitory machine readable storage medium of example 9, wherein before the execution of the first version of the software by the first CCP pod is stopped, the instructions are to cause the programmable circuitry to queue first operations, the first operations corresponding to a first execution time and a first importance value, and after a failure to execute the first operations in association with the first CCP pod and after commencement of the second CCP pod, retry execution of the first operations in association with the second CCP pod.

Example 16 includes the non-transitory machine readable storage medium of example 9, wherein before the execution of the first version of the software by the first CCP pod is stopped, the instructions are to cause the programmable circuitry to after an indication that the first CCP pod is to be stopped, and before commencement of the second CCP pod, queue a first operation, and after the commencement of the second CCP pod, execute the first operation.

Example 17 includes a method including detecting, by executing an instruction with programmable circuitry, an installation script, the installation script including a second version of software in system storage of a first cluster of a plurality of clusters, a first version of the software installed in the first cluster, after execution of the first version of the software by a first cluster control plane (CCP) pod is stopped, starting, by executing an instruction with programmable circuitry, a second CCP pod, the second CCP pod instantiated with the second version of the software, and directing an application programming interface (API) operation request received at the first cluster to the second CCP pod without directing the API operation request to the first CCP pod.

Example 18 includes the method of example 17, wherein the API operation request is a provisioning request.

Example 19 includes the method of example 17, further including instructing the second CCP pod to store the second version of the software in a personality database, and remove the first version of the software from the personality database.

Example 20 includes the method of example 17, including instantiating a third CCP pod belonging to a second cluster based on the second version of the software that is stored in a personality database of the second cluster.

Example 21 includes the method of example 17, including upgrading the first cluster to execute the second version of the software after the execution of the first version of the software by the first CCP pod is stopped.

Example 22 includes the method of example 17, including, before the execution of the first version of the software by the first CCP pod is stopped, scheduling operations to be executed by the first CCP pod based on a first execution time of a first operation being shorter than a second execution time of a second operation, and based on a first importance value of the first operation representing more importance than a second importance value of the second operation.

Example 23 includes the method of example 17, including before the execution of the first version of the software by the first CCP pod is stopped, queuing first operations, the first operations corresponding to a first execution time and a first importance value, and after a failure to execute the first operations in association with the first CCP pod and after commencement of the second CCP pod, retrying execution of the first operations in association with the second CCP pod.

Example 24 includes the method of example 17, including, before the execution of the first version of the software by the first CCP pod is stopped after an indication that the first CCP pod is to be stopped, and before commencement of the second CCP pod, queuing a first operation, and after the commencement of the second CCP pod, executing the first operation.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
machine readable instructions;
programmable circuitry to at least one of instantiate or execute the machine readable instructions to:
detect an installation script, the installation script including a second version of software in system storage of a first cluster of a plurality of clusters, a first version of the software installed in the first cluster; and
after execution of the first version of the software by a first cluster control plane (CCP) pod is stopped, start execution of a second CCP pod, the second CCP pod instantiated with the second version of the software; and
interface circuitry to direct an application programming interface (API) operation request received at the first cluster to the second CCP pod without directing the API operation request to the first CCP pod.

2. The system of claim 1, wherein the API operation request is a provisioning request.

3. The system of claim 1, wherein the programmable circuitry is to instruct the second CCP pod to:
store the second version of the software in a personality database; and
remove the first version of the software from the personality database.

4. The system of claim 1, wherein the programmable circuitry is to instantiate a third CCP pod belonging to a second cluster based on the second version of the software that is stored in a personality database of the second cluster.

5. The system of claim 1, wherein after the execution of the first version of the software by the first CCP pod is stopped, the programmable circuitry is to upgrade the first cluster to execute the second version of the software.

6. The system of claim 1, wherein before the execution of the first version of the software by the first CCP pod is stopped, the programmable circuitry is to schedule operations to be executed by the first CCP pod based on a first execution time of a first operation being shorter than a second execution time of a second operation, and based on a first importance value of a first operation being representing more importance than a second importance value of a second operation.

7. The system of claim 1, wherein before the execution of the first version of the software by the first CCP pod is stopped, the programmable circuitry is to:
queue first operations, the first operations corresponding to a first execution time and a first importance value, and
after a failure to execute the first operations in association with the first CCP pod and after commencement of the second CCP pod, retry execution of the first operations in association with the second CCP pod.

8. The system of claim 1, wherein before the execution of the first version of the software by the first CCP pod is stopped, the programmable circuitry is to:
after an indication that the first CCP pod is to be stopped, and before commencement of the second CCP pod, queue a first operation; and
after commencement of the second CCP pod, execute the first operation.

9. A non-transitory machine readable storage medium comprising instructions to cause programmable circuitry to at least:
detect an installation script, the installation script including a second version of software in system storage of a first cluster of a plurality of clusters, a first version of the software installed in the first cluster;
after execution of the first version of the software by a first cluster control plane (CCP) pod is stopped, start a second CCP pod, the second CCP pod instantiated with the second version of the software; and
directing an application programming interface (API) operation request received at the first cluster to the second CCP pod without directing the API operation request to the first CCP pod.

10. The non-transitory machine readable storage medium of claim 9, wherein the API operation request is a provisioning request.

11. The non-transitory machine readable storage medium of claim 9, wherein the instructions are to cause the programmable circuitry to instruct the second CCP pod to:
store the second version of the software in a personality database; and
remove the first version of the software from the personality database.

12. The non-transitory machine readable storage medium of claim 9, wherein the instructions are to cause the programmable circuitry to instantiate a third CCP pod belonging to a second cluster based on the second version of the software that is stored in a personality database of the second cluster.

13. The non-transitory machine readable storage medium of claim 9, wherein after the execution of the first version of the software by the first CCP pod is stopped, the instructions are to cause the programmable circuitry to upgrade the first cluster to execute the second version of the software.

14. The non-transitory machine readable storage medium of claim 9, wherein before the execution of the first version of the software by the first CCP pod is stopped, the instructions are to cause the programmable circuitry to schedule operations to be executed by the first CCP pod based on a first execution time of a first operation being shorter than a second execution time of a second operation, and based on a first importance value of the first operation representing more importance than a second importance value of the second operation.

15. The non-transitory machine readable storage medium of claim 9, wherein before the execution of the first version of the software by the first CCP pod is stopped, the instructions are to cause the programmable circuitry to:
queue first operations, the first operations corresponding to a first execution time and a first importance value; and
after a failure to execute the first operations in association with the first CCP pod and after commencement of the second CCP pod, retry execution of the first operations in association with the second CCP pod.

16. The non-transitory machine readable storage medium of claim 9, wherein before the execution of the first version of the software by the first CCP pod is stopped, the instructions are to cause the programmable circuitry to:
after an indication that the first CCP pod is to be stopped, and before commencement of the second CCP pod, queue a first operation; and
after the commencement of the second CCP pod, execute the first operation.

17. A method comprising:
detecting, by executing an instruction with programmable circuitry, an installation script, the installation script including a second version of software in system storage of a first cluster of a plurality of clusters, a first version of the software installed in the first cluster;
after execution of the first version of the software by a first cluster control plane (CCP) pod is stopped, starting, by executing an instruction with programmable circuitry, a second CCP pod, the second CCP pod instantiated with the second version of the software; and
directing an application programming interface (API) operation request received at the first cluster to the second CCP pod without directing the API operation request to the first CCP pod.

18. The method of claim 17, wherein the API operation request is a provisioning request.

19. The method of claim 17, further including instructing the second CCP pod to:
store the second version of the software in a personality database; and
remove the first version of the software from the personality database.

20. The method of claim 17, including instantiating a third CCP pod belonging to a second cluster based on the second version of the software that is stored in a personality database of the second cluster.

21. The method of claim 17, including upgrading the first cluster to execute the second version of the software after the execution of the first version of the software by the first CCP pod is stopped.

22. The method of claim 17, including, before the execution of the first version of the software by the first CCP pod is stopped, scheduling operations to be executed by the first CCP pod based on a first execution time of a first operation being shorter than a second execution time of a second operation, and based on a first importance value of the first operation representing more importance than a second importance value of the second operation.

23. The method of claim 17, including:
before the execution of the first version of the software by the first CCP pod is stopped, queuing first operations, the first operations corresponding to a first execution time and a first importance value; and
after a failure to execute the first operations in association with the first CCP pod and after commencement of the second CCP pod, retrying execution of the first operations in association with the second CCP pod.

24. The method of claim 17, including, before the execution of the first version of the software by the first CCP pod is stopped:
after an indication that the first CCP pod is to be stopped, and before commencement of the second CCP pod, queuing a first operation; and
after the commencement of the second CCP pod, executing the first operation.
